(19) United States
(12) Patent Application Publication
(10) Pub. No.: US 2026/0050260 A1
(43) Pub. Date: Feb. 19, 2026

(54) INTEGRATION OF COPILOT REPLACEMENT SYSTEMS AND AI CONTROL SYSTEMS

(71) Applicant: INNOVATIVE SOLUTIONS & SUPPORT, INC., Exton, PA (US)

(72) Inventor: Shahram Askarpour, Exton, PA (US)

(21) Appl. No.: 18/913,365

(22) Filed: Oct. 11, 2024

Related U.S. Application Data
(63) Continuation-in-part of application No. 18/665,465, filed on May 15, 2024.
(60) Provisional application No. 63/518,194, filed on Aug. 8, 2023.

(51) Int. Cl. G05D 1/229; G05D 1/226; G05D 1/227; G05D 101/15; G05D 109/22; G05D 111/10; G06V 20/58; G08G 5/26; G10L 15/18; G10L 15/22; G10L 15/30

(52) U.S. Cl. CPC G05D 1/229; G05D 1/226; G05D 1/2272; G06V 20/58; G08G 5/26; G10L 15/1815; G10L 15/22; G10L 15/30; G05D 2101/15; G05D 2109/22; G05D 2111/10; G10L 2015/223

(57) ABSTRACT

This disclosure relates to systems and methods for providing a copilot replacement system (CPRS) that enables dual-pilot or multi-pilot aircraft to be operated by a single onboard pilot. This disclosure also relates to systems and method for integrating an artificial intelligence (AI) controller into the aircraft, which autonomously provides assistance with controlling operation of the aircraft. Amongst other things, the solutions described herein can autonomously execute various functions for controlling the aircraft and/or can establish connections with one or more copilot ground base stations (GBSs) that enable ground-based copilots to remotely provide assistance with operating the aircraft. Both onboard pilots and remote pilots can be provided with override controls that enable the pilots to override, cancel, and/or modify actions undertaken by the AI controller.

### CROSS-REFERENCE TO RELATED APPLICATIONS

This application is a continuation-in-part of U.S. patent application Ser. No. 18/665,465 filed on May 15, 2024, which claims benefit of, and priority to, U.S. Provisional Ser. No. 63/518,194 filed on Aug. 8, 2023. This application also is related to U.S. patent application Ser. No. 18/665,465 filed on May 15, 2024. The contents of the above-identified applications are herein incorporated by reference in their entireties.

### TECHNICAL FIELD

This disclosure describes, inter alia, improved systems, methods, and techniques for providing a copilot replacement system that enables aircraft to be operated by a single onboard pilot. This disclosure also describes systems, methods, and techniques for integrating an artificial intelligence (AI) controller with a copilot replacement system and/or aircraft.

### BACKGROUND

Various types of aircraft are designed to be operated by a crew of two pilots, such as a pilot and co-pilot. For example, in the United States, many commercial aircraft that are subject to certification regulations set forth under Part 25 of Title 14 of the Code of Federal Regulations (CFR) (sometimes referred to as “Part 25 aircraft”) are certified to require two pilots. Likewise, many types of military aircraft (e.g., such as military transports) also are designed to be operated by two pilots.

Traditionally, aircraft designed for dual-pilot operations cannot be operated by a single pilot for a variety of reasons, including safety concerns, cockpit layout constraints, and certification requirements. For example, in many scenarios, the physical layout or design of a cockpit can make it impractical for a single pilot to operate an aircraft. This is because certain components (e.g., such as circuit breakers, control switches, displays, etc.) may be accessible to one pilot, but not easily accessible by the other pilot. Additionally, these dual-pilot aircraft are typically operated in a manner such that the duties of the pilot and copilot are segregated or divided to allow both pilots to be engaged during all phases of flight. For example, during certain phases of flight, a copilot may handle duties associated with callouts, managing checklists, and ensuring proper procedures are executed, while a pilot performs a primary role in controlling, navigating and maneuvering the aircraft. With respect to Part 25 aircraft, pilot roles are typically designated as “pilot flying” (e.g., which can correspond to the role performed by a pilot) and “pilot monitoring” (e.g., which can correspond to the role performed by a copilot). These physical and operational constraints can make it difficult for a single onboard pilot to operate a dual-piloted aircraft and, consequently, many certification agencies (e.g., the Federal Aviation Agency or FAA) will require a crew of at least two pilots to operate such aircraft.

### BRIEF DESCRIPTION OF DRAWINGS

To facilitate further description of the embodiments, the following drawings are provided, in which like references are intended to refer to like or corresponding parts, and in which:

FIG. 1A is a block diagram of a system in accordance with certain embodiments;

FIG. 1B is a block diagram of an exemplary aircraft system that includes a CPRS in accordance with certain embodiments;

FIG. 2 is a block diagram of an exemplary aircraft system that does not include a CPRS;

FIG. 3A is a block diagram of a copilot GBS in accordance with certain embodiments;

FIG. 3B is an illustration demonstrating an exemplary configuration for a copilot GBS in accordance with certain embodiments;

FIG. 3C is a display that can be generated using a flight augmentation system in accordance with certain embodiments;

FIG. 4A is a flow chart for a method of operating a CPRS in accordance with certain embodiments;

FIG. 4B is a flow chart for a method of operating a copilot GBS in accordance with certain embodiments;

FIG. 5A is a block diagram illustrating exemplary features of an AI control system according to certain embodiments;

FIG. 5B is a block diagram illustrating AI control system integrated into an aircraft according to certain embodiments; and

FIG. 6 is a flow chart for a method an exemplary method according to certain embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “connect,” “connected,” “connects,” “connecting,” “couple,” “coupled,” “couples,” “coupling,” and the like should be broadly understood and refer to linking two or more elements or signals, electrically, electronically, mechanically and/or otherwise. Connecting/coupling may be for any length of time, e.g., permanent or semi-permanent or only for an instant. “Electrical connecting,” “electrical coupling,” and the like should be broadly understood and include connecting/coupling involving any electrical signal, whether a power signal, a data signal, and/or other types or combinations of electrical signals. “Mechanical connecting,” “mechanical coupling,” and the like should be broadly understood and include physical or mechanical connecting/coupling of all types.

The term “primary” in the description and in the claims, if any, is used for descriptive purposes and not necessarily for describing relative importance. For example, the term “primary” can be used to distinguish between a first component and an equivalent redundant component; however, the term “primary” is not necessarily intended to imply any distinction in importance between the so-called primary component and the redundant component. Unless expressly stated otherwise, any redundant component(s) should be treated as being able to operate interchangeably with any primary component(s) of the system, in tandem with any primary component(s), and/or in reserve for any primary component(s) (e.g., in the event of a component/system failure).

The terms “pilot,” “co-pilot,” “pilots,” “co-pilots,” “operator,” “operators,” or the like should be broadly understood to refer to any individual or user, and not necessarily to individuals who are certified to operate or fly aircraft. Additionally, while the term “copilot” may be used to refer to an individual who assists a primary pilot in some instances, it should be understood that a copilot may perform the same or similar functions or roles as a pilot in some scenarios. Thus, the terms “pilot” and “copilot” can be used interchangeably in this disclosure.

### DETAILED DESCRIPTION OF EXEMPLARY EMBODIMENTS

The present disclosure relates to systems, methods, apparatuses, and techniques for providing a copilot replacement system (CPRS) that facilitates replacement of a copilot in traditional dual-pilot aircraft. The present disclosure relates to techniques for integrating an artificial intelligence (AI) control system with a CPRS and/or aircraft.

Integration of the CPRS into these dual-pilot aircraft enables the aircraft to be operated by a single onboard pilot. As explained in further detail below, the CPRS solutions described herein can autonomously execute various functions traditionally performed by a copilot and can enable a remote, ground-based pilot to be connected to aircraft in various scenarios. Additionally, these CPRS solutions can include modified cockpit configurations that provide a pilot with direct access to components that are traditionally located on a copilot's area of the aircraft.

In certain embodiments, the CPRS can autonomously execute various functionalities that are traditionally performed by a copilot. Additionally, in certain embodiments, the CPRS can include a high-speed GND data link that establishes a connection with one or more copilot ground base stations (GBSs) to enable a remotely situated copilot to provide assistance in operating the aircraft. Examples of these autonomous and remotely assisted functionalities are described throughout this disclosure.

The CPRS can comprise components that are installed in various portions of an aircraft, such as a cockpit, electronic and equipment (EE) bay, and aircraft exterior. Amongst other things, the CPRS can include a monitoring, checklist and warning system (MCWS), cockpit monitoring system, communications management system, GND data links, a flight augmentation system, and an exterior vision system. Additionally, the CPRS can be directly or indirectly coupled to a variety of avionics components or devices, such as an aircraft's MCDUs (multi-function control and display units), data concentrators, flight management systems (FMSs), flight guidance computers (FGCs), multimode radios, flight and safety data computers (FSDCs), sensor systems, and/or cockpit displays, actuators, switches and controls. The data received from these components can enable the CPRS to autonomously perform various functionalities and/or can be relayed to a copilot GBS to provide a remote copilot with access to the data.

In many embodiments, the MCWS can be installed in the cockpit of an aircraft and can be configured to execute checklist functions, instrument monitoring functions, call out functions, warning functions, and other functions typically performed by an onboard copilot. The MCWS can output data or information associated with executing these and other functions on a display device situated proximate to the pilot. The display device permits the pilot to monitor, access, and control all of the functions typically performed by a traditional onboard copilot, and to monitor all instruments, data, and information that would typically be presented to an onboard copilot. Additionally, the MCWS can communicate with the pilot (via both audio and visual means) to provide information, warnings, and alerts, and to facilitate performance of checklists, call outs, and other functions.

The CPRS solution also can enable a pilot to easily access and control various components, devices, switches, or controls that are traditionally located on a copilot's side of a cockpit. For example, any mechanical circuit breakers located in a copilot's area of a cockpit can be replaced with electronic circuit breakers that can be controlled by displays, switches or controls located adjacent to the pilot. AIong similar lines, any control switches, displays, and/or instrument readings located in a copilot's area of the cockpit can be presented to, and controlled by, the pilot using displays, switches or controls located adjacent to the pilot.

The communications management system and/or GND data links can establish a connection to a copilot GBS, thereby enabling a remote, ground-based copilot to be connected to the aircraft during some or all phases of flight. This connection permits the remote copilot to control various functionalities of the aircraft and to assist the pilot in operating the aircraft. Additionally, a cockpit monitoring system installed in the cockpit of the aircraft can provide the remote copilot with visibility of the flight instruments, warning indicators, and other cockpit components, as well as provide a forward-facing view through the windshield of the aircraft. The copilot's visibility also can be supplemented with information from exterior vision systems (such as LiDAR and cameras located on the exterior of the aircraft). A headset connected to the copilot GBS can enable the remote copilot to audibly communicate with the pilot in performing various functions (e.g., checklists, call outs, etc.), and to communicate with other entities (e.g., air traffic controllers, other aircraft) over the aircraft's multimode radios.

In the event that an onboard pilot becomes incapacitated (or otherwise is unable to operate an aircraft), a flight augmentation system can execute functions that assist a remote copilot with landing the aircraft. Amongst other things, the flight augmentation system can enable the aircraft to be safely landed on approved surfaces (e.g., runways), as well as unapproved surfaces (e.g., open fields, roads, bodies of water, etc.) in emergency scenarios when instrument landing systems (ILSs) are unable to guide the descent and landing of the aircraft. In these scenarios, the flight augmentation system can generate simulated ILS signals and provide these signals to an autopilot function, flight guidance component, and/or flight management system to navigate and land the aircraft on an approved surface and/or an unapproved surface. Additionally, the flight augmentation system can generate augmented aircraft displays that annotate camera views with various objects to assist a copilot with monitoring landing operations on these surfaces. Further details of the flight augmentation system are provided below.

In certain embodiments, the CPRS may further include override controls that permit an onboard pilot to override control of the aircraft by any remote entities, such as a copilot GBS. In some scenarios, these override controls can reallocate control of the aircraft to the onboard pilot in the event that a data link is breached by a malicious actor and/or the pilot desires to more fully control certain operations of the aircraft. In some cases, the override controls can completely sever or disable a communication link to the remote entities. In other scenarios, the override controls can be utilized to restrict or limit control of the aircraft by the copilot GBS.

In certain embodiments, the aircraft also may be equipped with an artificial intelligence (AI) control system that works in conjunction with the CPRS to provide additional assistance to the onboard pilot in operating the aircraft without requiring a second pilot to be physically present on board. The AI control system may be integrated as a component of the CPRS and/or may be an independent system that communicates with the CPRS. Amongst other things, the AI control system may be configured to autonomously analyze operational parameters and environments associated with operating the aircraft and autonomously execute various flight-related functions to assist the onboard pilot and/or remote copilot in safely and efficiently operating the aircraft.

In certain embodiments, the AI control system may include a computer vision system that analyzes visual data from various sources, such as cameras, infrared sensors, and/or LiDAR systems installed on the aircraft. This computer vision system may be configured to detect and identify objects, obstacles, weather conditions, and other relevant features in the aircraft's external environment. Additionally, the computer vision system may be configured to analyze visual data from cameras installed inside the aircraft to monitor cockpit displays or instruments, assess passenger cabin conditions, detect unusual activities in cargo areas, and identify potential equipment malfunctions or safety hazards within the aircraft's interior. In some embodiments, the computer vision system may include one or more deep learning models, such as one or more convolutional neural networks, to process and interpret the visual data. The AI control system may use the analysis information generated by the computer vision system to enhance situational awareness, assist in navigation, detect potential hazards, and support decision-making processes. In some examples, the computer vision system may help identify nearby aircraft or obstacles, assess runway conditions, or detect adverse weather patterns, allowing the AI control system to provide relevant information or recommendations to the pilot or autonomously adjust the aircraft's flight path if necessary.

In certain embodiments, the AI control system also may include a natural language processing (NLP) system that, inter alia, enables advanced communication and interaction capabilities. This NLP system may be designed to interpret and process verbal commands from pilots (e.g., including an onboard pilot and ground-based copilot), analyze radio communications from air traffic controllers and other aircraft, and generate natural language responses or alerts. In some examples, the NLP system also may assist in managing checklists and procedures. In some configurations, the NLP system may include one or more machine learning models, such as one or more transformer-based architectures and/or one or more large language models (LLMs), that are trained or fine-tuned to understand commands, conditions, communications, and/or terminologies in aviation-specific domains. The AI control system may utilize the analysis information processed by the NLP system to enhance situational awareness and make informed decisions about necessary actions, such as adjusting the flight path, modifying system settings, or alerting the pilot to potential conflicts or discrepancies between received instructions and the planned route.

In certain embodiments, the AI control system also may include an autonomous controller that is configured to execute various functions associated with monitoring and analyzing the aircraft and its operational environment, as well as implementing actions for controlling the aircraft and its subsystems. The autonomous controller may utilize the analysis information generated by the computer vision system and/or NLP system, as well as inputs or data from various aircraft sensors, components, and avionics, to interpret various operational or situational parameters associated with operating the aircraft. The autonomous controller also may be configured to autonomously execute a wide range of actions for controlling the aircraft and/or its subsystems, including actions for adjusting flight parameters, avoiding obstacles, managing aircraft systems and responding to emergency scenarios. The autonomous controller may work in conjunction with the onboard pilot and/or remote pilot to assist with operating the aircraft, providing recommendations and assistance while allowing for pilot override when necessary.

The onboard pilot and/or remote copilot may have access to override controls, which enable them to override, cancel, and/or modify any action taken by the autonomous controller. These override controls may be implemented through various mechanisms. In some examples, the override controls may include voice-based override commands (e.g., which are interpreted by the NLP system), interactive options presented on displays or interfaces, or physical controls, such as dedicated buttons or switches. The override controls may allow pilots to quickly intervene if they disagree with an autonomous decision or action, ensuring that judgment of the onboard pilot and/or remote copilot can always take precedence over decisions or choices made by the AI control system. These override controls help maintain a balance between leveraging the benefits of AI assistance and preserving ultimate human control over aircraft operations.

The CPRS and autonomous technologies described herein provides a variety of benefits and advantages. Amongst other things, these technologies enable dual-piloted or multi-piloted aircraft to be operated by a single onboard pilot, rather than by a team of two or more pilots. The technologies described herein can provide a cost-effective solution of upgrading or retrofitting these aircraft with equipment that enables the aircraft to be operated by a single onboard pilot, which can be particularly beneficial in scenarios where there is limited availability of pilots.

Additional advantages can be attributed to the installation configuration of the CPRS, which provides the pilot with all access and control over all the equipment, devices, and functions typically provided to, or performed by, an onboard copilot. This can help overcome hurdles associated with traditional cockpit layouts or designs, such as those that impede the pilot's access to certain components.

Other advantages can be attributed to the ability of the CPRS and/or AI control system to autonomously execute various copilot functions and/or communicate with the pilot in connection with performing these functions. Configuring the CPRS and/or AI control system to execute these functions can eliminate, or at least mitigate, occurrences of human errors in operating aircraft.

Further advantages can be attributed to configurations that enable a remote copilot to be connected to the system during some or all phases of flight and/or which enable the AI control system to control operation of the aircraft during some or all phase of flight. The remotely connected copilot and/or autonomous controller can provide assistance in various ways. In some scenarios, the remote copilot can be connected to the aircraft to mitigate the workload of the pilot and aid the pilot in performing various tasks (e.g., checklists, call outs, etc.). Additionally, or alternatively, the AI control system can autonomously perform certain tasks to alleviate the workload of the onboard pilot. Furthermore, in the event that a pilot becomes incapacitated or otherwise unable to operate an aircraft, the remote copilot and/or autonomous controller can take control of the aircraft and ensure the aircraft is safely landed.

Other advantages can be attributed to the ability of the AI control system to enhance situational awareness and decision-making capabilities, potentially improving safety and efficiency in aircraft operations. By autonomously monitoring various parameters and executing certain actions, the AI control system may reduce pilot workload and provide an additional layer of assistance, complementing the roles of both the onboard pilot and remote copilot. These and other advantages are described throughout this disclosure.

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

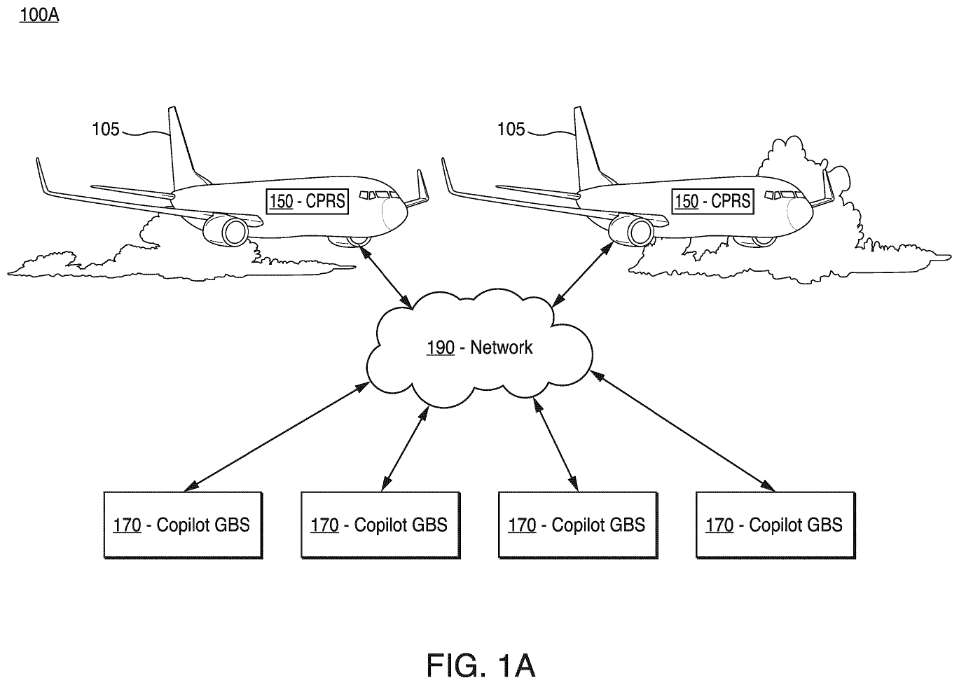

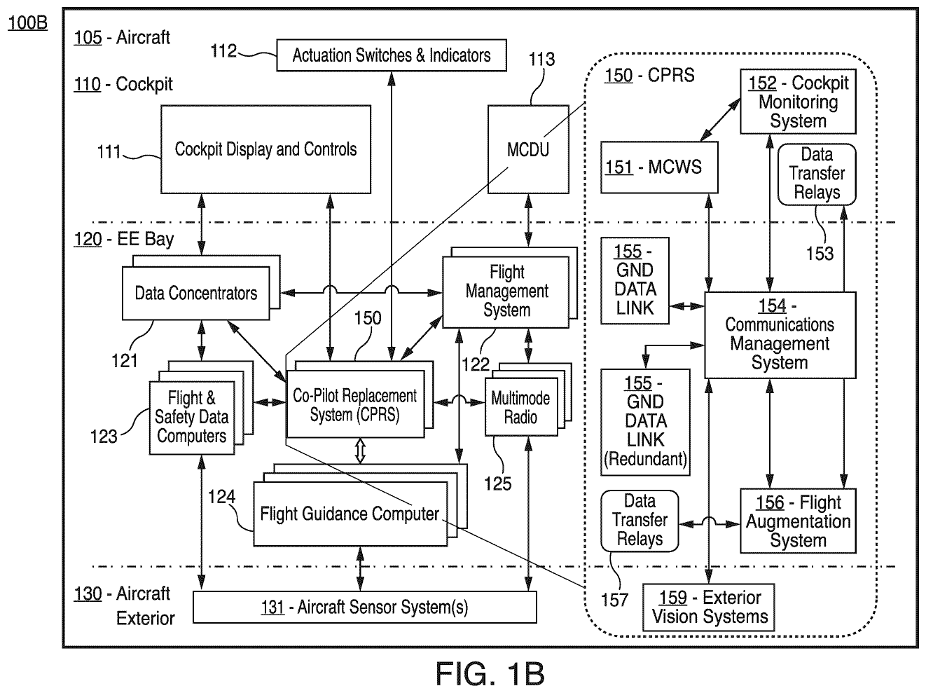

FIG. 1A is a block diagram of exemplary system 100A according to certain embodiments. The system 100A comprises one or more aircraft 105, each of which includes a copilot replacement system (CPRS) 150. The system 100A further includes one or more copilot ground base stations (GBSs) 170, and a network 190 that connects each of the one or more aircraft 105 to one or more of the copilot ground base stations (GBSs) 170.

As explained throughout this disclosure, the CPRS 150 installed in an aircraft 105 can be configured to execute various functions traditionally performed by a copilot and permits the aircraft 105 to be operated by a single onboard pilot. Amongst other things, the CPRS 150 can communicate with an onboard pilot in connection with operating an aircraft 105, and can autonomously execute functions for performing checklists, instrument monitoring, call outs, and warnings. Additionally, the CPRS 150 can be configured to activate controls for autonomously navigating and landing the aircraft (e.g., in emergency scenarios).

Each aircraft 105 can be coupled or connected to one or more copilot ground base stations (GBSs) 170 over a network 190. The network 190 can include various types of air-to-ground and/or air-to-air communication networks. In some instances, the network 190 can comprise a SATCOM (satellite communication) network, a datalink communication network, a VHF (Very High Frequency) communication network, a HF (High Frequency) communication network, an ACARS (Aircraft Communications Addressing and Reporting System) network, an ATN (Aeronautical Telecommunication Network), a FANS (Future Air Navigation System) network, and/or other types of networks 190. The network 190 can further include, or be connected to, a local area network (e.g., a Wi-Fi network), a personal area network (e.g., a Bluetooth network), a wide area network, an intranet, the Internet, a cellular network, and/or other types of networks. Amongst other things, network 190 enables bi-directional communications between each aircraft 105 and one or more copilot GBSs 170.

Each copilot GBS 170 can be situated on the ground or the Earth's surface. Each copilot GBS 170 enables a remote copilot to be connected to one or more aircraft 105. The copilot GBS 10 can be connected to an aircraft 105 during any or all phases of flight (e.g., pre-flight, pushback and taxi, takeoff, climb, cruise, descent, approach, landing. taxi to the gate, shutdown and de-boarding, etc.) to aid an onboard pilot with operating an aircraft or performing related functions. The copilot GBS can enable the remote copilot to perform all actions or activities that could be performed traditionally by a copilot (or pilot) physically located on the aircraft 105. For example, the copilot GBS 170 can communicate with the CPRS 150 installed in the aircraft to perform functions such as scheduling, modifying, and executing flight plans, communicating with the onboard pilot, executing checklist functions, monitoring flight systems and warning indicators, maneuvering the aircraft, landing the aircraft, tuning radio or communication devices, communicating with the air traffic control and/or other aircraft, controlling autopilot, autothrust, and/or autoland functions, etc.

In some scenarios (e.g., such as when an onboard pilot becomes incapacitated or unable to operate an aircraft), the copilot GBS 170 can be used to control and operate all functionalities of the aircraft. Additionally, in these scenarios, the copilot GBS 170 can enable a remote copilot to activate and control autopilot and autonomous landing functions. In other scenarios, the copilot GBS 170 can play a more limited role that aids an onboard pilot with operating the aircraft (e.g., such as in scenarios involving heavy workloads). Additional details of the copilot GBS 170 are described in further detail below.

FIG. 1B is a diagram of an exemplary aircraft system 100B that includes a CPRS 150 according to certain embodiments. In general, the aircraft system 100B may be installed in any type of airplane and/or other type of aircraft 105. In some examples, the aircraft system 100B may be installed in a commercial aircraft or military aircraft that was originally designed to be operated by at least two individuals (e.g., a pilot and a copilot), such as Part 25 aircraft in the commercial sector and/or military transport aircraft.

The aircraft system 100B includes a copilot replacement system (CPRS) 150 that enables an aircraft to be operated with a single pilot physically present within the aircraft. As explained in further detail below, the CPRS 150 can be directly or indirectly networked and/or interfaced with various components of the aircraft system 100B, and can execute or manage functions that are typically performed by a copilot during all phases of flight. In some embodiments, the CPRS 150 can operate independently to perform the roles and functions traditionally performed by the copilot. Additionally, or alternatively, the CPRS 150 can permit a remotely situated copilot located at a copilot GBS 170 to assist with operating the aircraft 105.

In some scenarios, an aircraft 105 that was initially designed to be operated by a crew of two pilots may be updated or retrofitted to include the CPRS 150, thereby enabling the dual-pilot aircraft to be operated with only a single pilot onboard the aircraft 105. In other scenarios, an original design of the aircraft 105 may be equipped with the CPRS 150.

As shown in FIG. 1B, various components can be installed in an aircraft 105 (e.g., such as components labeled as 111-113, 121-125, 131, 151-159, and 161) that are directly or indirectly coupled to, and interfaced with, the CPRS 150. The components of the aircraft 105 can be installed in various locations, such as in a cockpit 110, an electronic and equipment (EE) bay 120, and/or on or near an aircraft exterior 130. While FIG. 1B illustrates an exemplary arrangement for installing components within the cockpit 110, EE bay 120 and aircraft exterior 130, it should be recognized that the arrangement of these components can vary and locations of certain components can be changed or varied in some embodiments.

Additionally, while FIG. 1B illustrates the aircraft system 100B as including one of each of the component (e.g., such as components labeled as 111-113, 121-125, 131, 151-159 and 161) for simplicity purposes, it should be recognized that the aircraft system 100B can include any number of each component. For example, in some embodiments, the aircraft system 100B may include only one of each component. In other embodiments, the aircraft system 100B may include two or more of each component (e.g., such as to provide redundancy for various subsystems). A brief description of each of these components is provided below, along with examples of locations of where these components may be installed in the aircraft 105.

In certain embodiments, the cockpit 110 of the aircraft 105 can include, inter alia, cockpit display and controls 111, actuation switches and indicators 112, and/or one or more multi-function control and display units (MCDU) 113. As explained in further detail below, the cockpit 110 also can include certain components of the CPRS 150, including at least one monitoring, checklist, and warning system (MCWS) 151, at least one cockpit monitoring system 152, at least one data transfer relay 153, and at least one override control 161.

The cockpit display and controls 111 in the cockpit 110 can include various instruments, screens, and/or controls that provide a pilot with information about the aircraft's systems, flight parameters, and navigation, and allow the pilot to interact with and control various functions of the aircraft. These can include primary flight displays (PFDs) and other displays (e.g., weather radar displays, engine performance displays, fuel status displays, system status displays, navigational charts, etc.), as well as flight controls, power controls, avionics controls, etc. Exemplary cockpit display and controls 111 can include an airspeed indicator (ASI), attitude indicator (or artificial horizon), heading indicator (or directional gyro), turn coordinator (or turn and bank indicator), altimeter, vertical speed indicator (VSI), and/or other flight instruments.

Additionally, the cockpit display and controls 111 can be updated to include a display that enables the pilot to access and perform the functions that are typically only accessible by the copilot. For example, in some traditional cockpit layouts, certain instruments, screens, and/or controls, such as those that facilitate instrument comparisons, call outs, and checklists for emergency, normal and abnormal operations, only may be accessible to the co-pilot (or not easily accessible to the pilot). To account for this, the cockpit display and controls 111 for the pilot may include a display (e.g., MCWS 151) that enables the pilot to access and control these and other functions that are traditionally performed by the copilot. In certain embodiments, the display, which allows for performance of copilot functions, can be a dedicated display or additional display that is installed in the cockpit 110. Alternatively, the corresponding functionalities can be incorporated into an existing display (e.g., such as the MCDU 113 located on the pilot side of the cockpit 110).

Any or all of the cockpit display and controls 111 can be coupled to the CPRS 150 to permit bi-directional exchange information with the CPRS 150. This connection can enable the CPRS 150 to access, monitor, and control the cockpit display and controls 111 and/or actuation switches and indicators 112 in an automated or autonomous fashion and/or can enable a ground-based copilot connected to the CPRS 150 to access, monitor, and control the cockpit display and controls 111 and/or actuation switches and indicators 112. The cockpit display and controls 111 also can be coupled to other aircraft components, such as the data concentrators 121, to access various types of information as described below.

The actuation switches and indicators 112 in the cockpit 110 can be utilized used by the pilot to display and control various flight instructions, systems, and functions of the aircraft. Exemplary actuation switches and indicators 112 can be utilized to control landing gear, flaps, engines, autopilot functions, autothrottle functions, autonomous landing systems, lighting systems, communication systems, fuel selector systems, etc.

Additionally, the actuation switches and indicators 112 also include controls for manipulating physical equipment or components located on a copilot area of the aircraft 105. For example, in certain traditional cockpit layouts, one or more mechanical circuit breakers may be positioned on the copilot side of the cockpit 110, which is not easily accessible by the pilot. In this scenario, the mechanical circuit breakers can be replaced with electronic circuit breakers that are monitored, managed, and/or controlled by the actuation switches and indicators 112 located on the pilot side of the aircraft. The actuation switches and indicators 112 can similarly permit the pilot to monitor, manage, and/or control other types of components that are positioned on the copilot side of the cockpit in a similar manner. In some cases, a display provided on the pilot side of the cockpit (e.g., provided by components 111, 113, or 151) additionally, or alternatively, can be configured to monitor, manage, and/or control the circuit breakers and/or other physical components located on the copilot side of the aircraft 105.

The actuation switches and indicators 112 also can be coupled to the CPRS 150 to enable the CPRS 150 to monitor, manage, and/or control the physical components. This connection can enable the CPRS 150 to access, monitor, and control the actuation switches and indicators 112 in an automated or autonomous fashion and/or can enable a ground-based copilot connected to the CPRS 150 to access, monitor, and control the actuation switches and indicators 112.

The MCDU 113 in the cockpit 110 can provide a computer interface that permits pilots to input data and receive feedback about various aspects of the aircraft's operations, including fuel consumption, flight path, and altitude, and can be utilized to perform functions associated with flight planning, navigation, and performance computations. In some cases, the MCDU 113 can utilize data obtained from the FMS 122, FGC 124, and/or other the navigator system to perform these and other functions. Additionally, in some embodiments, the MCDU 113 can be configured with some or all of the aforementioned functionalities associated with performing functions traditionally performed by a copilot and/or controlling physical components situated on copilot side of the cockpit 110 (e.g., such as instrument comparison, call outs, checklist monitoring, etc.).

In some traditional cockpit layouts, the cockpit 110 may be outfitted with a pair of MCDUs 113 (e.g., a first MCDU 113 utilized by the pilot and a second MCDU 113 utilized by the copilot). In scenarios where the CPRS 150 is installed in the aircraft, the second MCDU 113 for the copilot can optionally be removed. Additionally, as explained in further detail below, an MCDU simulator can be installed at a copilot GBS 170 to provide a remote copilot located on the ground with the same information and functionality that traditionally would be provided to an onboard copilot located in the cockpit 110.

Each of the components included in the cockpit 110 (including the cockpit display and controls 111, actuation switches and indicators 112, and/or MCDUs 113) of the aircraft 105 can be directly or indirectly to the CPRS 150 to allow for bi-directional exchange of information between the CPRS 150. For example, the CPRS 150 can be coupled to the cockpit display and controls 111 to obtain data related to the aircraft's systems, flight parameters, and navigation, and to enable the CPRS 150 to manipulate corresponding settings for the displays and controls. Likewise, the CPRS 150 can be coupled to the MCDU 113 (either directly or indirectly via the FMS 122) to obtain data related to the aircraft's operations (e.g., fuel consumption, flight path, flight plan, altitude, attitude, etc.), and to enable the CPRS 150 to provide various inputs to the MCDU 113 (e.g., inputs for specifying a flight planning parameters, navigation, performance parameters, etc.). Additionally, the connections between the CPRS 150 and the actuation switches and indicators 112 can enable the CPRS 150 to activate/deactivate and/or control the aircraft's landing gear, flaps, engines, autopilot functions, autothrottle functions, lighting systems, communication systems, fuel selector systems, circuit breakers, etc. Any of the components connected to the CPRS 150 can be controlled by a remote copilot and/or autonomously controlled by the CPRS 150.

In certain embodiments, the EE bay 120 can include, inter alia, one or more data concentrators 121, one or more flight management systems (FMSs) 122, one or more flight and safety data computers (FSDCs) 123, one or more flight guidance computers (FGCs) 124, and/or one or more multimode radios 125. Each of the components included in the EE bay 120 (including the data concentrators 121, FMSs 122, FSDCs 123, FGCs 124, and multimode radios 125) of the aircraft 105 can be directly or indirectly coupled to the CPRS 150 to allow for bi-directional exchange of information. Additionally, as explained in further detail below, the EE bay 120 also may include certain components of the CPRS 150, including one or more communications management systems 154, one or more GND (ground) data links 155, one or more flight augmentation systems 156, and/or one or more data transfer relays 157.

Each data concentrator 121 can include a centralized computing device that collects, processes, and distributes data from various systems and components throughout the aircraft, thereby streamlining the flow of data and facilitating efficient communication between different avionics systems. Amongst other things, the data concentrator 121 gathers data from a wide range of sources (e.g., including FMS 122, FGC 124, FSDC 123, flight instruments, engine sensors, navigation systems, communication systems, and other avionics subsystems), and processes the data to ensure its integrity, accuracy, and compatibility. The data concentrator 121 can act as a central hub to distribute the processed data to the relevant systems, displays, or avionics units that require the information. The data concentrator 121 can be coupled to the CPRS 150 to enable the CPRS 150 to obtain the aforementioned data collected from the various aircraft sources (along with corresponding integrity and accuracy information), and to enable the data concentrator 121 to receive, process, and monitor data from the CPRS 150.

Each FMS 122 can include an onboard computer system that assists the flight crew in managing various aspects of flight planning, navigation, and guidance. Amongst other things, the FMS 122 enables the flight crew to input and optimize the aircraft's flight plan (e.g., while considering factors such as waypoints, airways, altitude constraints, weather conditions, performance characteristics, fuel consumption, etc.). In many cases, the FMS 122 receives data from various sources, such as GPS (Global Positioning System), VOR (VHF Omnidirectional Range), and/or IRS (Inertial Reference System) to determine the aircraft's position, track, and altitude, and it assists in accurately navigating the aircraft along the planned route, including tracking waypoints, avoiding obstacles, and conducting instrument approaches, while providing precise lateral and vertical guidance to the flight crew throughout the flight. Additionally, the FMS 122 also may interface with the aircraft's autopilot and autothrottle systems to automatically manage and/or control engine thrust and navigation of the aircraft.

The FMS 122 can be coupled to the CPRS 150, thereby enabling the CPRS 150 to access any or all of the aforementioned data generated by the FMS 122, and permitting the CPRS 150 to provide commands or inputs (e.g., relating to flight plans, autopilot/autothrottle systems, etc.) for controlling the FMS 122. The FMS 122 also can be coupled to a variety of other aircraft components, such as the MCDUs 113, data concentrators 121, FSDCs 123, and multimode radios 125.

Each FSDC 123 can include an onboard computer system that is configured to collect, process, and analyze flight data for safety and operational purposes. Amongst other things, the FSDC 123 can monitor and improve flight safety by recording and analyzing various parameters related to the aircraft's performance, systems, and crew actions, and can detect alerts related to various types of safety concerning events (e.g., excessive speed, altitude deviations, abnormal engine parameters, or other anomalies that may require immediate attention or action).

The FSDC 123 can be coupled to the CPRS 150 to enable the CPRS 150 to obtain any or all of the aforementioned data, and to enable the FSDC 123 to record and analyze actions taken by the FSDC 123. The FSDC 123 also can be coupled to the data concentrators 121, aircraft sensor systems 131, and/or other components of the aircraft 105.

Each FGC 124 can provide automated control and guidance functions to assist the pilot in flying the aircraft. Amongst other things, the FGC 124 can execute flight plans generated by the FMS 122, and can autonomously steer or direct the aircraft along the desired track, including following waypoints, airways, and instrument approaches. Additionally, the FGC 124 can perform functions that permit the pilot to engage and control the autopilot and autothrottle systems in controlling the aircraft, and can provide visual guidance cues on displays included in the cockpit 110 of the aircraft.

The FGC 124 can be coupled to the CPRS 150 to enable the CPRS 150 to obtain data (e.g., heading, flight plan, attitude, altitude, etc.) from the FGC 124 and/or manipulate or control of the functions performed by the FGC 124. The FGC 124 additionally can be coupled to the FMSs 122, aircraft sensor systems 131, and/or other components of the aircraft 105.

Each multimode radio 125 can include a radio communication system that is capable of operating on multiple frequency bands or modes, and can support both data and voice communications. The multimode radio 125 provides the flight crew with the ability to communicate with various ground-based and air-based entities (e.g., air traffic control, other aircraft, and ground-based stations) using various communication protocols. The specific functions and capabilities of a multimode radio can vary depending on the aircraft and its avionics system. In some cases, the multimode radio 125 can include VHF (Very High Frequency) communication capabilities, HF (High Frequency) communication capabilities, data link communication capabilities, Mode S transponder capabilities, and/or other communication capabilities.

The multimode radio 125 can be coupled to the CPRS 150 to enable the CPRS 150 to communicate with ground-based and air-based entities and/or to monitor communications with these entities. The multimode radio 125 additionally can be coupled to the FMSs 122, aircraft sensor systems 131, and/or other components of the aircraft 105.

In certain embodiments, the aircraft exterior 130 can include, inter alia, various aircraft sensor systems 131, each including one or more sensors and/or one or more actuators. Exemplary aircraft sensor systems 131 can include angle of attack (AoA) sensors, pitot tubes or sensors, static ports, temperature sensors, global position systems (GPSs), radar systems, radar altimeters, LIDAR (light detecting and ranging) systems, camera systems, antennas, wingtip devices, and/or other related components. As explained in further detail below, the aircraft exterior 130 also can be equipped with certain components of the CPRS 150, such as an exterior vision system 159 that includes one or more camera systems and/or one or more LIDAR systems (and/or alternative types of vision systems).

Each of the aircraft sensor systems 131 (and/or corresponding actuators) can be coupled to the CPRS 150 to enable the CPRS 150 to obtain data generated by these systems and/or control operation of these systems. The aircraft sensor systems 131 additionally can be coupled to the FSDCs 123, multimode radios 125, and/or other components of the aircraft 105.

As shown in FIG. 1B, the CPRS 150 can comprise various components installed throughout the cockpit 110, EE bay 120, and aircraft exterior 130. In certain embodiments, the cockpit 110 can include at least one MCWS 151, a cockpit monitoring system 152, one or more data transfer relays 153, and/or one or more override controls 161. The EE bay 120 can include a communications management system 154, one more GND (ground) data links 155, a flight augmentation system 156, and one or more data transfer relays 157. The aircraft exterior 130 also can be equipped with one more exterior vision systems 159. The CPRS 150 can include any number the aforementioned components (e.g., only one of each component or two or more of each component, such as to provide redundancy). A brief description of each of these components is provided below.

The CPRS 150 can include at least one MCWS 151 and, in many embodiments, a pair of MCWSs 151 for redundancy purposes. Each MCWS 151 can be directly or indirectly connected to any or all of the aircraft components (including any or all of the components in FIG. 1B), and can receive various types of data, information, and parameters from each of the components. Amongst other things, the MCWS 151 can utilize the data obtained from these components (e.g., data concentrators 121, FMS 122, FGC 124, etc.) to execute checklist functions, instrument monitoring functions, and warning functions. These functions can be provided via an output device accessible to the pilot (e.g., an interactive display provided by the cockpit display and controls 111, MCDU 113, and/or another device). While these functions are typically performed by an onboard copilot, the MCWS 151 can be located proximate to the pilot and can communicate with the pilot (e.g., via audio means, display means, and/or GUIs) to execute these functions.

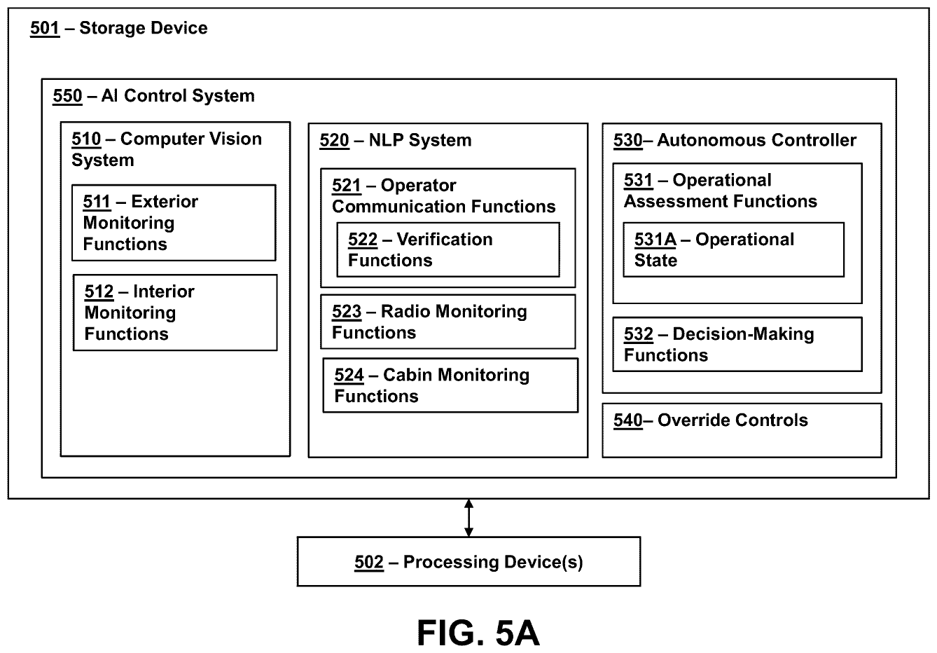

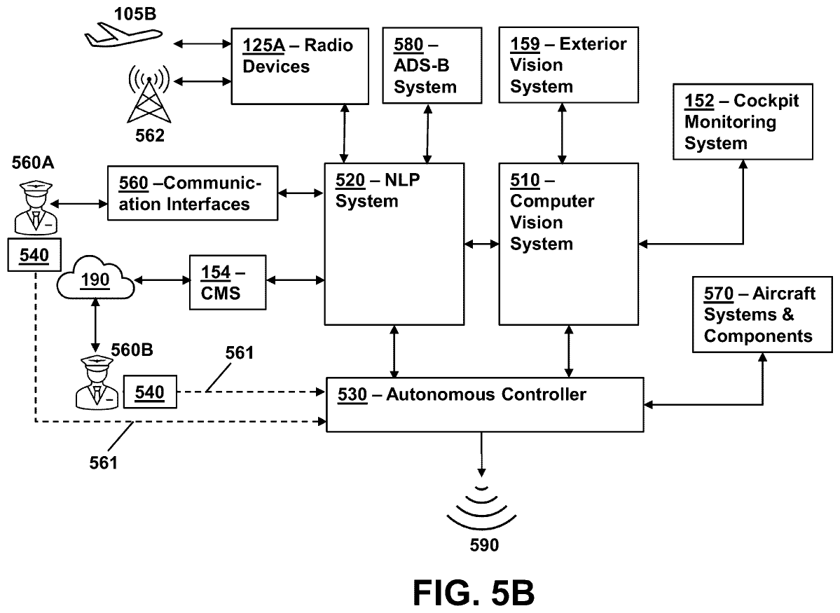

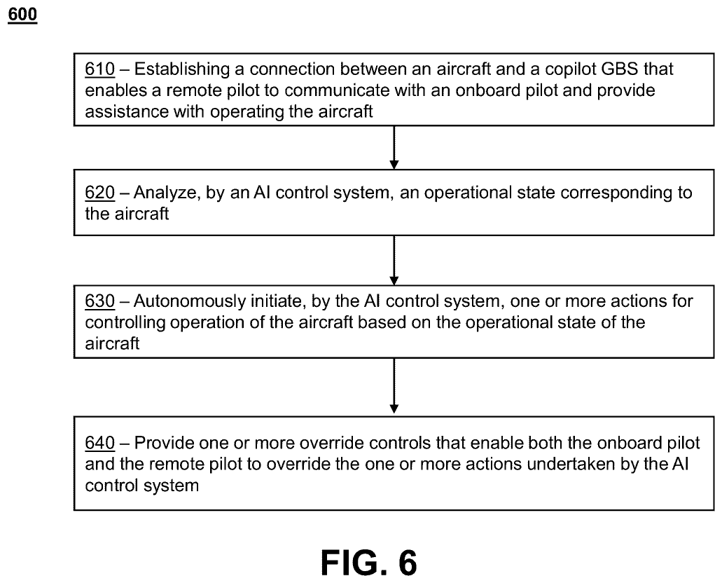

In certain embodiments, the MCWS 151 can be configured to transition among an onboard control operational mode, an autonomous operational mode and a remote control operational mode. In the onboard control operational mode, a pilot may manually interact with and control the MCWS 151 to perform checklist functions, instrument monitoring functions, and warning functions. In the autonomous operational mode, the MCWS can independently or autonomously perform checklist functions, instrument monitoring functions, and warning functions, and can communicate directly with the onboard pilot to ensure that all corresponding flight procedures are adhered to and that the aircraft's instruments are within their operational parameters. In some embodiments, the autonomous operational mode can utilize algorithms and sensor integration to autonomously detect and alert the pilot to any anomalies or safety-critical information, effectively fulfilling the role of a copilot. In some embodiments, some or all of the functionalities performed in the autonomous operational mode may be executed by an AI control system and/or NLP system (described below with reference FIGS. 5A-5B and 6). In the remote control operational mode, the MCWS interfaces with a copilot ground base station (GBS), allowing a remotely situated copilot to access and control the MCWS functionalities. This mode enables the remote copilot to assist the onboard pilot by managing checklists, monitoring instruments, and issuing warnings. The MCWS's multi-mode capabilities help to ensure that the aircraft can be operated safely and efficiently, whether autonomously or with remote assistance, adapting to the varying demands of each flight scenario.

In some cases, the MCWS 151 may be configured in the onboard control operational mode or autonomous operational mode by default. When the pilot desires the assistance of a remote copilot, the MCWS 151 may be transitioned to the remote control operational mode. Similarly, after the checklist functions, instrument monitoring functions, and warning functions have been performed (or when the connection to the remote copilot has been terminated), the MCWS 151 may transition from the remote control operational mode back to the onboard control operational mode or autonomous operational mode.

The checklist functions executed by the MCWS 151 can provide a structured set of procedures used by the flight crew during various phases of flight. These checklists help ensure that critical tasks are completed in a systematic and thorough manner, reducing the risk of human error. Exemplary checklist functions can provide checklists covering a wide range of activities, e.g., such as pre-flight checks, pre-takeoff checks, in-flight checks, pre-landing checks, abnormal checks (e.g., such in scenarios of equipment, component, or aircraft malfunctions), normal checks, and emergency procedure checks. In some embodiments, the checklists can be displayed in electronic form on a screen and/or output display dedicated to the MCWS 151 (or on other screens and/or output devices located in the cockpit).

Traditionally, checklists are typically displayed on an output device located on the copilot's side of the cockpit. In the aircraft system 100B, the MCWS 151 can enable the pilot to access the checklist functions, and can permit the checklists to be displayed on an output device located on pilot's side of the cockpit.

In certain embodiments, during operation of an aircraft, the MCWS 151 can autonomously execute checklist functions that are traditionally performed manually by a copilot. For example, for each checklist, the MCWS 151 can be configured to output (e.g., via a speaker on the MCWS 151 or in the cockpit) step-by-step checklist instructions to the pilot, and receive confirmations (e.g., via a microphone or display device) that each checklist instruction has been completed in an appropriate manner. In some embodiments, the MCWS 151 may utilize, or communicate with, an AI control system (see FIGS. 5A-5B and 6) in connection with autonomously performing these functions. Additionally, or alternatively, a ground-based copilot that is remotely connected to the aircraft 105 via the CPRS 150 can access the MCWS 151 and communicate with the pilot to ensure completion of the checklists. For example, the ground-based copilot can verbally communicate with the pilot over a communication link (e.g., GND data link 155) to read out and confirm the checklist instructions.

The instrument monitoring functions executed by the MCWS 151 can obtain data from various aircraft instruments, sensors, and displays, and provide real-time or near real-time information on the aircraft's status and performance. This information assists the flight crew with making informed decisions, and ensuring that the aircraft operates within safe parameters. Amongst other things, the monitoring functions can monitor and/or display parameters or readings from flight instruments (e.g., flight parameters such as airspeed, altitude, vertical speed, attitude (pitch and roll), heading, and navigation data), engine instruments (e.g., parameters such as engine speed, temperature, pressure, and fuel consumption), fuel management systems (e.g., parameters such as quantity, distribution, and fuel flow rates), electrical system monitors (e.g., parameters indicating the status of various electrical components), and/or hydraulic system monitors (e.g., parameters indicating hydraulic pressure and hydraulic system health), and compare these parameters with benchmark values or ranges to determine whether the parameters are within acceptable operating ranges. While copilots traditionally perform functions of monitoring the aircraft's instruments and ensuring the instrument readings are normal, these functions can be performed by automatically or autonomously by the MCWS 151 (or AI control system) and/or by a ground-based copilot in communication with aircraft 105.

The warning monitoring functions executed by the MCWS 151 can provide the pilot with visual and/or audio-based warnings, messages, callouts, and alerts, similar to how they would be verbally communicated from a co-pilot to a pilot. For example, in some embodiments, the MCWS 151 can analyze and/or compare instrument readings to identify abnormal operating parameters and, in response to detecting the abnormal operating parameters, the MCWS 151 can output (e.g., via a speaker or a display device) the warnings, messages, callouts, and alerts to the pilot and/or a ground-based copilot remotely connected to the aircraft 105.

The cockpit monitoring system 152 can include any type of system or device that is capable of monitoring one or more displays (e.g., instrument panels, display devices, etc.) located in the cockpit of the aircraft. The configuration of the cockpit monitoring system 152 can vary.

In some embodiments, the cockpit monitoring system 152 can comprise one or more camera devices that capture views inside the cockpit and/or in the front exterior of the aircraft 105. In some examples, the cockpit monitoring system 152 can include at least two forward-facing cockpit cameras, one of which is focused on the instrument panel in the cockpit and the other focused on the external view through the windshield of the aircraft 105.

Additionally, or alternatively, the cockpit monitoring system 152 can include data connections and/or devices that receive data directly or indirectly from one or more displays (e.g., instrument panel displays and/or other displays) located in the cockpit of the aircraft, and which relay the data from the one or more displays to the CPRS 150.

An additional cockpit monitoring system 152 can be installed for purposes of redundancy (e.g., which includes a second set of cameras to be used in the event of a primary cockpit monitoring system failure and/or which includes a second set of data connections to the CPRS 150).

In certain embodiments, the cockpit monitoring system 152 also can include image recognition software that is configured to detect various obstacles, hazards, and/or safety-impacting flight conditions. In one example, the image recognition software can analyze the video or image data collected by a camera focused on a windshield view to identify external hazards, such as approaching aircraft, birds, inclement weather conditions, and/or other hazards external to the aircraft. In another example, the image recognition software can analyze the video or image data collected by a camera focused on the aircraft's instrument panel to detect internal warnings, abnormal instrument conditions, caution indications, and/or the like. Additionally, the cockpit monitoring system 152 (or other component) can provide warnings or alerts to the pilot (e.g., audibly via speakers and/or visually via a display device) based on detecting these obstacles, hazards, and/or safety-impacting flight conditions. In some embodiments, the cockpit monitoring system 152 may utilize, or communicate with, an AI control system and/or computer vision system (see FIGS. 5A-5B and 6) in connection with performing these functions.

Any appropriate image recognition software can be utilized for the purposes described herein. In certain embodiments, the image recognition software can utilize one or more neural network models and/or one or more deep learning models to detect the obstacles, hazards, and/or safety-impacting flight conditions. These learning models can comprise a convolutional neural network (CNN), or a plurality of convolutional neural networks, that are configured to execute object detection functions associated with identifying the aforementioned obstacles, hazards, and/or safety-impacting flight conditions. For example, the object detection functions can be executed on the video or image data to identify exterior obstacles (e.g., corresponding to aircraft, birds, weather conditions, etc.) and interior instrument settings that indicate warnings, abnormal instrument conditions, caution indications, and/or the like. In some embodiments, the CNN (or other computer vision model) can be pre-trained in a supervised fashion using a training set of images that are labeled to identify the obstacles, hazards, and/or safety-impacting flight conditions. In some embodiments, the image recognition software may be executed or performed by a computer vision system that is included in an AI control system (see FIGS. 5A-5B and 6).

Additionally, for embodiments in which the cockpit monitoring system 152 comprises one or more cameras, the video and/or images captured by the cameras of the cockpit monitoring system 152 can be transmitted (e.g., via GND data link 155) to the ground-based copilot station. The video or image feeds captured by cockpit monitoring system 152 can be output on one or more display devices located in the ground-based copilot station to enable a remotely situated copilot to view the instrument panel and/or exterior view of the aircraft 105.

Additionally, for embodiments in which the cockpit monitoring system 152 comprises data connections directly coupled to the instruments or displays in the cockpits, the data obtained via these connections can be transmitted (e.g., via GND data link 155) to the ground-based copilot station. The data can be output on one or more display devices (e.g., such as one or more simulated display devices) located in the ground-based copilot station to enable a remotely situated copilot to access data relating to the instrument panel and/or exterior view of the aircraft 105.

The data transfer relays 153 located in the cockpit 110 of the aircraft 105 can allow a ground-based copilot to manipulate (e.g., activate/deactivate, adjust settings, modify, alter, etc.) various switches and controls located in the cockpit 110. In some examples, the data transfer relays 153 enable the ground-based pilot to remotely manipulate switches or controls located in the cockpit, such as, e.g., the actuation switches and indicators 112 for controlling landing gear, flaps, engines, autopilot functions, autothrottle functions, autonomous landing systems, lighting systems, communication systems, fuel selector systems, electronic circuit breakers, etc. In further examples, the data transfer relays 153 can enable the ground-based pilot to remotely manipulate the MCWS 151 and/or cockpit monitoring system 152.

The communications management system 154 allows for bi-directional communication between the aircraft 105 and one or more ground-based copilot stations 170. The communications management system 154 comprises, or is coupled to, at least one GND data link 155, which can include a high-speed satellite communication device and/or other appropriate communication device. In certain embodiments, the aircraft system 100B can include two communications management systems 154 (each having a separate GND data link 155) for redundancy purposes.

In certain embodiments, the communications management system 154 is coupled to, and receives all data generated by, the data concentrators 121, as well as the video or image data from the cockpit monitoring system 152. The communications management system 154 can utilize the one or more GND data links 155 to transmit the video/image data (or other data obtained directly from the instruments and displays) from the cockpit monitoring system 152 and the data from the data concentrators 121 to the ground-based copilot station. Additionally, any data generated by other components of the aircraft system 100B (e.g., cockpit display and controls 111, actuation switches and indicators 112, MCDU 113, FMS 122, FSDCs 123, FGC 124, multimode radios 125, aircraft sensor systems 131, MCWS 151, flight augmentation system 156, data transfer relays, etc.) also can be provided to the communications management system 154, and transmitted to the ground-based copilot station via one of the GND data links 155.

The communications management system 154 also is configured to receive various communications and control commands from ground-based copilot stations in communication with the aircraft 105. Various types of communications and control commands can be received from a copilot GBS 170 to permit the remote copilot to seamlessly perform the functions of a traditional copilot that is located in the cockpit 110. In general, the control commands received from the copilot GBS 170 can be utilized to communicate with, and control, any of the aircraft components illustrated in FIG. 1B (e.g., (e.g., such as components 111-113, 121-125, 131, and 151-159, etc.) In some examples, the GND data link 155 can receive audio data from the ground pilot to facilitate verbal or audio communications with the pilot in the cockpit 110, air traffic controllers, and/or other aircraft located near the aircraft 105. In further examples, the GND data link 155 can receive control commands from a MCDU or simulated MCDU located at the copilot GBS 170 (e.g., such as MCDU commands that allow the remote copilot to control the FMS 122, FGC 124, and/or other aircraft components). In further examples, the GND data link 155 can receive control commands that enable the copilot to adjust or manipulate the cockpit display and controls and 111 and actuation switches and indicators 112 in the cockpit 110. Additionally, one or more data transfer relays 153 situated in the cockpit can allow the copilot to remotely control these components. Many other types of communications and control commands also can be received from the ground-based copilot.

For redundancy purposes, the communications management system 154 can comprise two high-speed satellite communication devices, as well as a HF radio device and/or a high-orbit satellite communication device. While the backup HF radio may provide low-resolution image or video data to the copilot GBS 170 pilot (e.g., due to limited bandwidth and slower communications), the data from the backup HF radio can be fused with the primary feeds and can be also utilized as primary communication device in case of a total failure of both high-speed satellite feeds.

The CPRS 150 can further include an exterior vision system 159 that supplements the aircraft sensor systems 131 on the exterior of the aircraft 105. Amongst other things, the exterior vision system 159 can include one or more additional cameras and/or one or more LiDAR (light detecting and ranging) systems. In certain embodiments, the exterior vision system 159 can include an infrared (IR) camera, a high-resolution video camera, and a LIDAR system. A second IR camera, second high-resolution camera, and second LiDAR system can be provided for redundancy. Any data captured by the exterior vision system 159 can be output on a display device to copilot located at a copilot GBS 170 and/or on a display device located in the cockpit 110. The exterior vision system 159 can be configured to capture various exterior environment data outside the aircraft 105, such as data identifying obstacles (e.g., other aircraft or objects) in the aircraft's flight path and/or in the vicinity of the aircraft.

Amongst other things, the visual data obtained by the exterior vision system 159 can be utilized to execute distance-measuring functions, which determine the distance to objects (e.g., other aircraft, obstacles, etc.) captured in the vision data. In certain embodiments, visual data captured by a pair of cameras can be utilized to determine a reference dimension for an object captured in the visual data. Additionally, or alternatively, the visual data captured by the LiDAR system can be utilized to determine the reference dimension. This reference dimension information can then be utilized to calculate distances between the aircraft 105 and the objects.

Additionally, the sensor or visual information data obtained by the exterior vision system 159 can combined or fused, and transmitted to a copilot GBS 170 over GND data link 155 to enable a ground-based copilot to determine the locations and distances of any objects captured by the cameras. For example, in certain embodiments, the copilot GBS 170 can output the image or video data captured by any of the aircraft cameras having external views (e.g., including any cameras included in the cockpit monitoring system 152 and/or exterior vision system 159) on a display device. When the image or video data is displayed, the copilot can select (e.g., using a mouse, touchscreen, or other input device) a location or object in the image or video data to obtain the distance of the aircraft 105 to the selected location or object. The reference information collected by the exterior vision system 159 can be utilized to calculate the distance to the location or object. In this manner, a remote copilot can easily determine and assess distances between the aircraft 105 and other objects or locations.

In certain embodiments, the CPRS 150 can further include a flight augmentation system 156 that, inter alia, executes functions to aid a ground-based based copilot in landing the aircraft 105. In some embodiments, the aircraft 105 can be equipped with two flight augmentation systems 156 for redundancy purposes. The flight augmentation system 156 can be activated and deactivated from a copilot GBS 170 in communication with the aircraft 105. Additionally, control of the flight augmentation system 156 (and any other components accessible by the copilot GBS 170) can be overridden by the pilot (or denied by the pilot) using onboard controls available in the cockpit 110 (e.g., which can be useful in the event that the data link security is breached).

When activated, the flight augmentation system 156 permits the remotely situated copilot to control and deploy various aircraft surfaces, equipment, and gear (e.g., such as landing gear, flaps, slats, air brakes, engine reversers, ground breaks, steering, etc.) for safely landing the aircraft and taxiing the aircraft off the runway after landing. In certain embodiments, one or more data transfer relays 157 located in the EE bay 120 can facilitate activation/deactivation of the flight augmentation system 156 and transfer control of the aircraft surfaces, equipment, and gear to the ground-based copilot. This can be beneficial in various scenarios, such as when the pilot becomes incapacitated or is otherwise unable to operate the aircraft 105.

In many scenarios, the flight augmentation system 156 may enable a remotely situated copilot to identify and selected an approved surface (e.g., a runway) for landing the aircraft 105.

In some scenarios (e.g., such as when aircraft components fail or emergency situations arise), the copilot may decide the safest option for landing the aircraft 105 is to select an unapproved surface for landing the aircraft 105 (e.g., such as a random parcel of land, a highway, or a body of water). As explained below, the flight augmentation system 156 provides several enhanced functionalities that enable the aircraft to be safely landed on the unapproved surface.

Some aircraft may be equipped with an autoland system that is configured to autonomously land the aircraft in certain situations. In traditional configurations, the autoland system uses instrument land system (ILS) signals received from a ground-based navigation system located at airports or approved runways to guide the aircraft during final approach and landing phases. Typically, the ground-based ILS generates localizer (LOC) signals for lateral guidance of the aircraft (e.g., to align the aircraft with a centerline of the runway) and glide scope (GS) signals for vertical guidance (e.g., to facilitate a steady descent path towards the touchdown zone on the runway). These signals are received by ILS receivers on the aircraft, and utilized by the autoland system to autonomously guide and land the aircraft. For example, the autoland system may utilize the autopilot system onboard the aircraft to control the aircraft's flight path using the ILS signals (e.g., to adjust the aircraft's heading and pitch to align it with the centerline of the runway and establish the correct glide path for landing), while the FMS 122 and/or FGC 124 calculates and manages the aircraft's approach, descent and landing profiles using the ILS signals. Additionally, in scenarios where in aircraft is in close proximity to the ground, the autoland system also may utilize radar altimeters onboard the aircraft to facilitate or execute aircraft flare maneuvers during the autonomous landing process.

In various scenarios (e.g., such as when a pilot becomes incapacitated or unable to operate the aircraft 105), the ground-based copilot can activate and control the autoland system in the aircraft to safely land the aircraft on an approved surface or runway. Once activated, the autoland system can utilize the ILS signals described above to navigate the aircraft to the approved surface and safely land the aircraft 105.

In scenarios when the aircraft is landing on an unapproved surface or runway, no ILS system (or corresponding signals) is present to safely guide the aircraft for landing. To account for this, the flight augmentation system 156 can be configured to generate simulated ILS control signals that emulate the ILS control signals that are generated by a ground-based ILS. These simulated ILS control signals can then be transmitted from the flight augmentation system 156 to the autopilot system, FMS 122 and/or FGC 124 (and other aircraft components), and utilized by the autoland system to navigate the aircraft to a designated touchdown location and land the aircraft on an unapproved surface. In this manner, the autoland system utilizes the simulated ILS control signals to safely navigate the aircraft towards the touchdown zone and land the aircraft on the unapproved surface, even though a ground-based ILS is not located within the range of the unapproved surface.

The simulated ILS control signals generated by the flight augmentation system 156 can include, inter alia, simulated glide scope signals that provide vertical guidance for navigating the aircraft 105 and simulated localizer signals that provider lateral guidance for navigating the aircraft 105. In certain embodiments, the flight augmentation system 156 can continuously generate and output the simulated glide scope signals and simulated localizer signals for usage by the autoland system, FMS 122, FGC 124, and/or other aircraft components during the approach and landing phases of flight. Other types of simulated control signals also may be generated by the flight augmentation system 156 for controlling the autoland system, FMS 122, FGC 124, and/or other components utilized to land the aircraft 105.

In some embodiments, the simulated ILS control signals can be generated, at least in part, using the information derived from the aircraft's sensing systems, such as sensor systems 131 and/or exterior vision system 159. As explained above, these sensing systems can include various types of devices (e.g., such as LiDAR systems, cameras, GPSs, etc.), and the data from these devices can be utilized to determine and track the three-dimensional (3D) coordinates or location of the aircraft 105, as well as the location of the touchdown zone on the unapproved surface. In turn, the location and reference information derived from the sensing systems, can be utilized to generate the simulated ILS controls signals that are utilized to navigate and land the aircraft.

In some embodiments, the flight augmentation system 156 also may generate simulated radar altimeter signals when the aircraft is in close proximity to the ground, and the simulated radar altimeter signals can be utilized by the autoland system to execute various types of aircraft flare maneuvers. The aircraft flare maneuvers can assist with reducing the aircraft's descent rate and bringing the aircraft to a smooth touchdown, and different aircraft flare maneuvers can be performed or executed based on the type of landing surface at the touchdown location (e.g., based on whether the aircraft is being landed on a grass field, body of water, etc.). In scenarios where the aircraft is landing on an unapproved surface, the simulated radar altimeter signals (and corresponding flare maneuvers) can be adjusted by the flight augmentation system 156 to accommodate the type of landing surface at the touchdown location.

In certain embodiments, certain aircraft 105 may not be pre-equipped with an autoland system. In this scenario, the flight augmentation system 156 can be configured with autoland functions, which can be utilized to navigate and land the aircraft in the same manner described above. Additionally, or alternatively, the flight augmentation system 156 can utilize the simulated ILS control signals to directly control the FMS 122, FGC 124, and/or other aircraft components in the same manner as would be done by an autoland system.

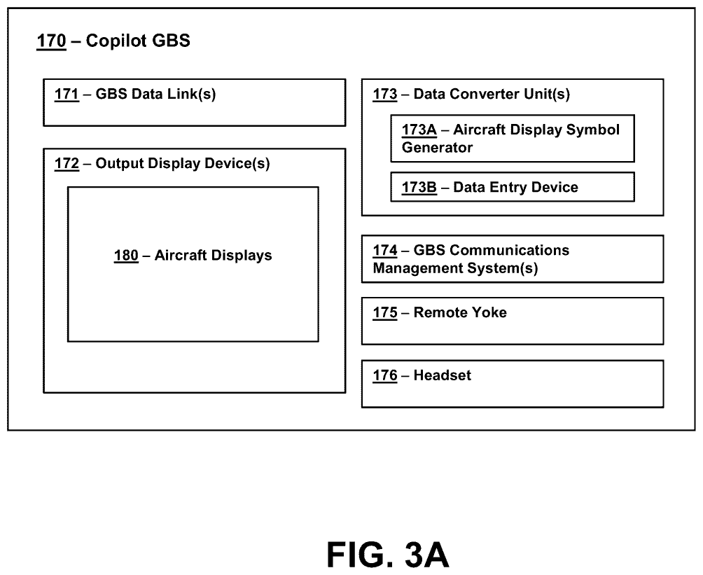

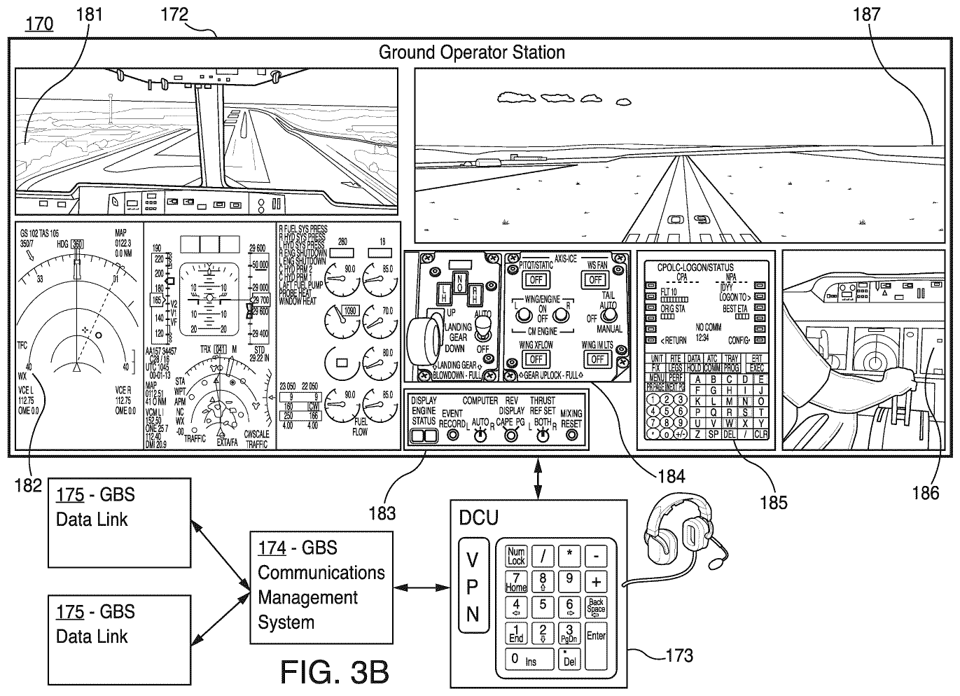

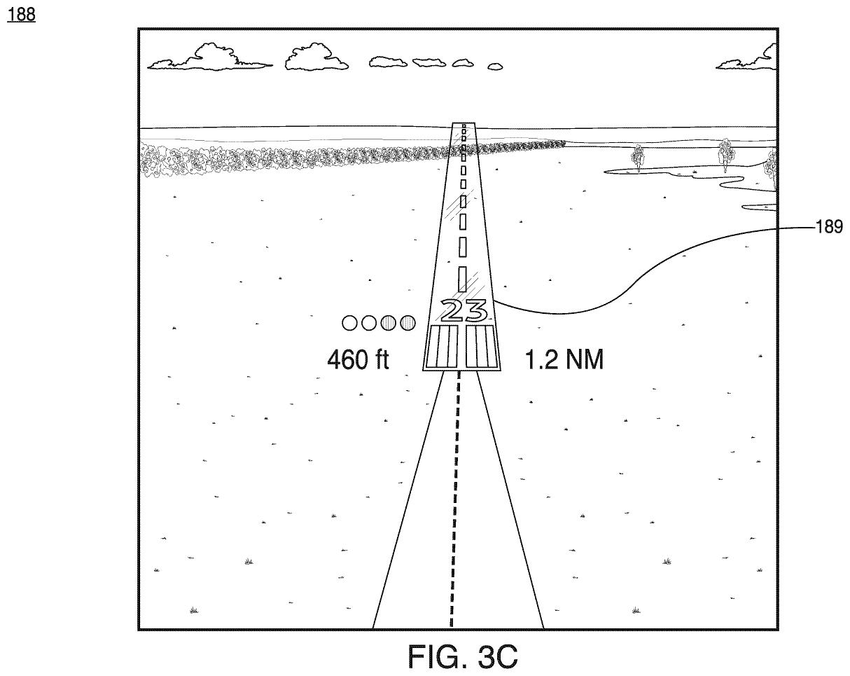

Additionally, the flight augmentation system 156 also can generate enhanced aircraft displays to aid a remote copilot situated at a copilot GBS 170 in monitoring and controlling a landing of the aircraft on unapproved surfaces or runways. For example, in some scenarios, the flight augmentation system 156 can generate an augmented reality (AR) display that emulates or simulates the landing of the aircraft on an approved runway (e.g., such as by augmenting a camera feed or display with a runway object overlay), despite the fact that the aircraft is being landed on an unapproved surface or runway. FIG. 3C, which is described in further detail below, illustrates an exemplary aircraft display that can be generated by the flight augmentation system 156.

The configuration of the augmented displays generated by the flight augmentation system 156 can vary. In some examples, the flight augmentation system 156 can generate a display that augments a camera view with a runway object on an unapproved surface where the aircraft is designated to land. Additionally, or alternatively, the camera view can be augmented with an object identifying the outline or perimeter of a runway on the unapproved surface. The camera view also can be augmented with other indicators and/or parameters, such as those that identify a designated touchdown point on the surface, obstacles located on or near the touchdown zone, aircraft parameters (e.g., altitude, speed, angle of attack, attitude, etc.).

In some cases, one or more of objects augmented into the camera view can be provided in a manner that enables the remote copilot to view the unapproved surface intended for landing (and to identify obstacles, such as holes, trees, or animals, on the surface). For example, if a runway object is added to the camera view, the runway object can be semi-transparent to permit the remote copilot to view the surface. In the event that the remote copilot identifies obstacles on the surface that raises safety concerns during landing, the copilot can transmit commands to the CPRS 150 (e.g., flight augmentation system 156) to cancel the landing on the unapproved surface and/or to select a new, safer surface for landing.

In certain embodiments, the CPRS may further include override controls 161 that permit an onboard pilot to override control of the aircraft by any remote entities, such as a copilot GBS 170 and/or a malicious actor that has intercepted or breached one or more of the GND data links 155. These override controls can reallocate control of the aircraft 105 to the onboard pilot and/or prevent remote entities from access or controlling the aircraft 105. In some cases, the override controls 161 may disable or deactivate the GND data links 155 to completely sever links to any remote entities.

Additionally, the override controls can be utilized to restrict or limit the control of the aircraft by a copilot GBS 170. In certain embodiments, the override controls can permit a pilot to provide selective access to any aircraft component (including, but not limited to any, any aircraft component illustrated in FIG. 1B or mentioned in this disclosure) and/or restrict access to any desired aircraft component (including, but not limited to any, any aircraft component illustrated in FIG. 1B or mentioned in this disclosure). In one example, the override controls may enable the onboard pilot to limit the role of remote copilot to certain functions, such as assisting with instrument monitoring, checklist, and/or warning functions (while restricting the remote copilot's access to other aircraft components and avionics systems that enable control of the aircraft's maneuvers, flight plans, and/or flight paths). In other examples, the override controls may enable the onboard pilot to control and access aircraft components and avionics systems during certain phases of flight, but may restrict or eliminate such control or access during other phases of flight.

FIG. 1B illustrates exemplary components that may be incorporated into an aircraft system 100B according to certain embodiments. However, the aircraft system 100B can be supplemented with additional components to implement the techniques described herein. For example, as described below with reference to FIGS. 5A-5B and 6, the aircraft system 100B also may equipped with an AI control system that further enhances the capabilities of the system and reduces workloads for both onboard pilots and/or remotely connected copilots.

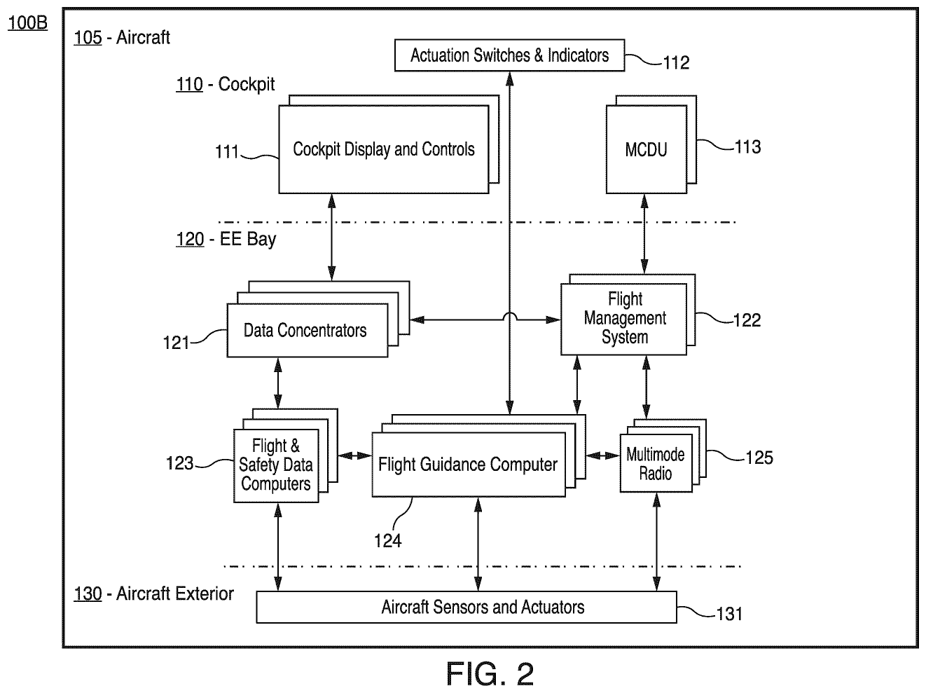

FIG. 2 illustrates a system 100C for an aircraft 105 that does not include the CPRS 150. This alternative system 100C demonstrates how various avionics or aircraft components may be coupled, or connected, to each other some typical arrangements. The arrangement of avionics or aircraft components does not permit a single onboard pilot to operate the aircraft safely, nor does it permit a remote, ground-based copilot to assist with operating the aircraft. In jointly viewing FIGS. 1B and 2, one of ordinary skill in the art would understand how the various components of the CPRS 150 can be installed and coupled to existing avionics or aircraft components to provide the enhanced functionalities described herein.

FIG. 3A is a block diagram demonstrating exemplary features of a copilot GBS 170 according to certain embodiments. Amongst other things, the copilot GBS 170 can include one or more computing devices, one or more GBS data links 171, one or more output display devices 172, one or more data converter units (DCUs) 173, one or more GBS communication management systems 174, one or more remote yokes 175, and/or one or more headsets 176. It should be understood that any of these components can be omitted from the copilot GBS 170 and/or additional components can be added to supplement the functionality of the copilot GBS 170.

The GBS datalink 171 and the GBS communication management system 174 can enable the copilot GBS 170 to communicate with various aircraft 105 (e.g., can communicate with data link 155 located on the aircraft and communication management system 154 on the aircraft). For example, as explained above, the GBS datalink 171 and the GBS communication management systems 174 can enable bi-directional communication between the copilot GBS 170 and an aircraft over a network 190, such as one that comprises a SATCOM network, a datalink communication network, a VHF communication network, a HF communication network, an ACARS network, an ATN, a FANS network, a local area network, a personal area network, a wide area network, an intranet, the Internet, a cellular network, and/or other types of networks. In certain embodiments, the GBS datalink 171 and the aircraft data link 155 can comprise high-speed satellite communication devices that communicate with each other over the network 190.

The GBS communication management system 174 can perform the same or similar functions as the communication management system 154 located on the aircraft, but can operate in a reverse fashion to transmit data to, and receive data from, the aircraft 105. Amongst other things, the GBS communication management system 174 can be coupled to an output display device 172 (and/or a computing device connected to the output display device 172) to receive control commands input or specified by a copilot located at the copilot GBS. The GBS communication management system 174 also can receive audio communications from the copilot (e.g., via headset 176 and/or a microphone). The GBS communication management system 174 can relay these commands and audio communications to the GBS datalink 171 for transmission to an aircraft 105 coupled to the copilot GBS 170 over the network 190.

The copilot GBS 170 further includes one or more output display devices 172 (e.g., which can include computer monitors, displays screens, and/or any other devices capable of displaying data or information). The output display devices 172 can generate and display various aircraft displays 180 to a copilot located at the copilot GBS 170, which can enable the copilot to remotely monitor an aircraft's operations, communicate with the pilot on the aircraft 105, transmit commands to the aircraft 105, and execute various functions in connection with operating the aircraft 105. In some embodiments, these aircraft displays 180 can be presented on graphical user interfaces (GUIs) and the copilot can interact with the GUIs to transmit communications, control commands, and/or other data to the aircraft 105.

In some embodiments, the copilot GBS 170 can comprise one or more computing devices (e.g., desktop computing devices, laptops, etc.). The one or more computing devices can execute some or all of the functions performed by the copilot GBS 170 (e.g., generating aircraft displays 180, receiving commands from pilots, receiving and transmitting data to and from the aircraft 105, etc.). The output display devices 172 (and DCU 173) can be connected to the one or more computing devices and/or can be integrated with the one or more computing devices. The one or more computing devices can be connected to Internet, which can be part of network 190. In certain embodiments, communications between the copilot GBS 170 and the aircraft 105 can be routed via the Internet and one or more connected SATCOM networks. In some scenarios, communications between the aircraft 105 and the copilot GBS 170 can be protected using a virtual private network (VPN) that includes a secure Internet hardware protocol. All communications over the network 190 can be protected using various encryption and cybersecurity protocols (e.g., such as to protect against intercept, manipulation, or denial of service).

The copilot GBS 170 further includes one or more DCUs 173 and, in some cases, a pair of DCUs for redundancy purposes. Each DCU 173 can be configured to receive some or all of the data transmitted over the network 190 from aircraft 105 to the copilot GBS 170. The DCU 173 can parse the data into different segments for generating the aircraft displays 180 and/or and can convert the data to formats that can be processed by the copilot GBS 170 and/or utilized to generate the aircraft displays 180 on an output display device 172.

In some examples, the DCU 173 can receive data from the aircraft's sensor systems, avionics, instruments and/or other components, and can include an aircraft display symbol generator 173A that is configured to generate visual representations of that data in the form of symbols, graphics, and/or text for the aircraft displays 180 (e.g., such as displays that visualize the aircraft's primary flight displays (PFDs), MCDUs, and/or other cockpit instruments). In further examples, the DCU 173 can be configured to perform the same or similar operations as the data concentrators 121 located on the aircraft 105 (e.g., such as collecting, processing, and distributing data from various systems, components, and aircraft displays). Additionally, in some embodiments, the DCU 173 can operate in a reverse fashion to convert data generated from the copilot GBS 170 for transmission to the aircraft 105 in a format that is usable by the aircraft's systems.

In certain embodiments, each DCU 173 also may include a data entry means 173B (e.g., a keypad and/or other input device) that enables the remote copilot to identify an aircraft 105 (e.g., by inputting a tail number of the aircraft 105). The remote copilot can utilize the data entry means to select an aircraft 105, and establish a connection between the selected aircraft 105 and the copilot GBS 170 over the network 190. Additionally, or alternatively, the data entry means 173B may include one or more GUIs presented on the output display devices 172 can be enable the remote copilot to select the aircraft 105, and establish the connection between the selected aircraft 105 and the copilot GBS 170.

The copilot GBS 170 can control the operations or flight path of the aircraft 105 in various ways. In some instances, the copilot GBS 170 may not have direct access to control the power lever, yoke and/or the rudder aircraft, but can manipulate them by sending control commands to the FGC 124 and/or FMS 122 (e.g., using a simulated MCDU display). In other scenarios, the copilot GBS 170 can include a remote yoke 175, a remote power lever, and/or remote rudder controls that enable the copilot to control the aircraft 105.

The copilot GBS 170 can further include a headset 176, which comprises one or more audio output devices (e.g., speakers or earphones) and one or more audio input devices (e.g., microphones). In some embodiments, the headset 176 can be coupled to the DCU 173 and/or other component of the copilot GBS 170. The headset 176 enables the copilot to communicate audibly with the pilot located on the aircraft 105. The headset 176 can further enable the copilot to engage in voice or audio-based communications with various ground-based and air-based entities (e.g., such as air traffic control, other aircraft, and other ground-based stations) over the over the multimode radios 125 located on the aircraft 105. The headset 176 can further receive communications from the aircraft 105 (e.g., such as communications from the pilot, communications received over the multi-mode radios 125, and/or communications generated by the CPRS 150) for output to the copilot.

FIG. 3B illustrates an exemplary configuration for a copilot GBS 170 according to certain embodiments. Amongst other things, the copilot GBS 170 comprises an output display device 172 that presents a GUI comprising a plurality of aircraft displays 180. In this exemplary scenario, the output displays device 172 includes a windshield display 181, an instrument display 182, a flight instrument control panel 183, flight control display 184, a simulated MCDU display 185, an instrument monitoring camera display 186, an exterior aircraft display 187, and a flight augmentation display 188.

It should be noted that the output display device 172 can include additional displays that are not explicitly illustrated. Additionally, one or more of the illustrated displays can be omitted in some embodiments. Moreover, the aircraft displays 180 can be arranged in different configurations on the GUI presented on the output display device 172. In some embodiments, the copilot GBS 170 can include a plurality of output display devices 172, and one or more of the aircraft displays 180 can be presented on a separate output display device 172 and/or on a separate GUI. A copilot operating at the copilot GBS 170 can interact with each of the aircraft displays 180 using various types of input devices (e.g., mouse devices, keyboards, joysticks, etc.).

The windshield display 181 can be configured to display the image and/or video data captured by one or more windshield-facing cameras included in the cockpit monitoring system 152 of the aircraft 105. In some embodiments, the windshield display 181 can provide a real-time or near real-time video feed from the one or more windshield-facing cameras. The windshield display 181 provides the remotely located pilot with visibility through the windshield of the aircraft, similar to the view that would be provided to an onboard copilot.

The instrument display 182 can electronically display and visualize various flight instruments for the aircraft 105. For example, the instrument display 182 can electronically emulate primary flight instruments (e.g., such as an ASI, attitude indicator (or artificial horizon), heading indicator (or directional gyro), turn coordinator (or turn and bank indicator), altimeter, VSI, engine status indicator, etc.) that are physically located in the aircraft 105. Other types of flight instruments also can be electronically presented to the copilot via the instrument display 182.

The flight instrument control panel 183 can electronically display and activate controls that enable the copilot to manipulate various avionics or aircraft components, such as controls for manipulating the autopilot functions, autothrottle functions, auto land functions, reverse engine functions, event recording, etc. The copilot can provide inputs via the flight instrument control panel 183 to activate/deactivate these functions and/or adjust settings associated with these functions.

The flight controls display 184 can electronically display controls that enable the copilot to manipulate landing gear, wing engines, anti-icing equipment, and/or other aircraft components. The copilot can provide inputs via the flight controls display 184 to activate/deactivate these components and/or adjust settings associated with these functions.

The simulated MCDU display 185 can electronically emulate, simulate, and/or display a traditional or physical MCDU (e.g., such as MCDU 113 physically located in the cockpit of the aircraft 105). The simulated MCDU display 185 can perform the same or similar functions as the MCDU 113 physically located in the cockpit of the aircraft 105. For example, the copilot can interact with the simulated MCDU display 185 to input commands and receive feedback for various aspects of the aircraft's operations, including fuel consumption, flight path, and altitude, and can be utilized to perform functions associated with flight planning, navigation, and performance computations. Amongst other things, the simulated MCDU display 185 permits copilot to directly control the FMS 122, FGC 124, and/or other navigation system in connection with generating and/or modifying flight plans for the aircraft 105. The simulated MCDU 185 display also can enable the copilot to receive data from, and send commands to, various subsystems or components coupled directly or indirectly to the CPRS 150, MCDU 113, and/or simulated MCDU 185.

The instrument monitoring camera display 186 can be configured to display the image and/or video data captured by one or more instrument-facing cameras included in the cockpit monitoring system 152 of the aircraft 105. In some embodiments, the instrument monitoring camera display 186 can provide a real-time or near real-time video feed from the one or more windshield-facing cameras. The instrument monitoring camera display 186 provides the remotely located pilot with visibility of the physical cockpit instruments located on the aircraft.

The exterior aircraft display 187 can be configured to display the image and/or video data captured by one or more exterior vision systems, which may include LiDAR systems and/or one or more cameras (e.g., one or more high-definition cameras and/or one or more infrared cameras). In some embodiments, the instrument monitoring camera display 186 can provide a real-time or near real-time video feed that is generated or captured using data from one or more cameras and/or LiDAR systems situated on the exterior of the aircraft 105. The exterior aircraft display 187 provides the remotely located pilot with visibility of the aircraft's surroundings (e.g., such as a forward facing view that can identify aircraft or other obstacles in or near the aircraft's flight path).

In certain embodiments, one or more of the displays presented via the copilot GBS 170 can include analysis information, alerts, and/or notifications generated by an AI control system (which is described in further detail below with reference to FIGS. 5A-5B and 6). Additionally, the displays and/or input devices included in the copilot GBS 170 may permit the remote copilot to communicate with, and transmit commands, to the AI control system.

As mentioned above, the copilot can utilize an input device (e.g., a mouse, touchscreen, joystick, etc.) to interact with the aircraft displays 180 and transmit commands to the aircraft 105 connected to the copilot GBS 170.

FIG. 3C illustrates another exemplary aircraft display 180 that can be presented by the output display device 172 and/or other display device of the copilot GBS 170 according to certain embodiments. This flight augmentation display 188 can be generated, at least in part, using the outputs of the flight augmentation system 156 installed on the aircraft. In some embodiments, the flight augmentation system 156 can additionally, or alternatively, be installed or located at the copilot GBS 170.

The flight augmentation display 188 can be configured to display a video feed from a camera that is augmented with various types of objects 189 (e.g., objects corresponding to runways, touchdown location indicators, distance measuring parameters, alert indicators, text, flight parameters, etc.). The video feed can represent a real-time or near real-time video feed that is captured by one or more cameras on the aircraft 105 (e.g., such as cameras or equipment included in the exterior vision system 159 and/or cockpit monitoring system 152). In some embodiments, the video feed can be generated, at least in part, by the LiDAR systems and/or cameras included in the exterior vision system 159. The flight augmentation system 156 onboard the aircraft 105 can augment the video feed the various objects, and the augmented video can be transmitted over the network 190 to the copilot GBS 170 and output via the flight augmentation display 188. In some embodiments, the flight augmentation system 156 (or certain functionalities performed by this component) can be located at the copilot GBS 170 and can augment video feeds after the feeds are transmitted over the network 190 and received by the copilot GBS 170.

In various scenarios, the flight augmentation system 156 can augment video feeds with visual cues that assist a remote copilot with landing the aircraft 105 on approved surfaces or runways. Additionally, in some particularly useful scenarios, the flight augmentation system 156 and flight augmentation display 188 can be utilized to enable a remote copilot to land an aircraft safely on an unapproved surface. The exemplary interface shown in FIG. 3C illustrates a runway object that is added to a video feed to simulate a landing on a surface that does not include a runway (e.g., an open field). The video feed also can be augmented with other objects corresponding to flight parameters (e.g., distance to touchdown, airspeed, angle of attack, etc.) that can assist the copilot with landing the aircraft.

As mentioned above, in scenarios involving an emergency landing on an unapproved surface, the ground-based copilot can provide commands identifying a touchdown location on the unapproved surface (e.g., an open field, body of water, etc.). This information can be transmitted over the network 190 to the flight augmentation system 156. Upon receiving the commands, the flight augmentation system 156 can generate simulated sensor information and guidance commands that instructs the autopilot functions, FMS 122, and/or FGC 124 that the unapproved surface is an approved landing surface, and/or which enables the FGC 124 to generate flight information or parameters for landing the aircraft on the unapproved surface similar to the manner in which the aircraft would be landed on an approved runway. For example, in some cases, the flight augmentation system 156 can calculate simulated signals for glide scope, localizer, glidepath, attitude, heading, altitude, and/or other flight information, and utilize these simulated signals to control the aircraft 105 during landing. Throughout the entire process of landing the aircraft 105 on the unapproved surface, the flight augmentation display 188 can augment with the video feed from the aircraft with a runway object (and/or other objects) to realistically simulate landing on an approved surface.

In the example shown in FIG. 3C, the runway object is presented as an overlay to a video feed, but is generated in a semi-transparent manner. This enables the copilot to view the actual surface underlying the runway object, and to assess whether there are any obstacles on the surface.

In certain embodiments, some or all of the above functionalities performed by the flight augmentation system 156 (e.g., such those which involve analyzing visual data and/or augmenting video feeds with various types of objects 189) may be performed by a computer vision system and/or AI control system described below.

Returning to FIG. 3A, certain aircraft displays 180 that present video feeds can be configured in a manner that permits a copilot to easily determine distance measures to objects captured in the video feed. For example, if a copilot desires to understand a distance between the aircraft 105 and an object (e.g., another aircraft, a flock of birds, a road, a building, etc.) captured in the video feed, the copilot can simply select the object on the output display device 172 (or associated GUI) and the distance to that object will be displayed to the copilot. As explained above, the exterior vision system 159 can be utilized to execute distance-measuring functions, which determine the distance to objects captured in the video feed. For example, the LiDAR system and/or cameras included in the exterior vision system 159 can be utilized to determine a reference dimension for a selected object captured, and the outputs of the distance-measuring functions can be displayed to the copilot (e.g., via one or more of the aircraft displays 180).

As mentioned above, the CPRS 150 can include image recognition software that is configured to detect various objects (e.g., obstacles, hazards, and/or safety-impacting flight conditions) captured in camera views. The image recognition software can be applied to identify and/or detect objects in any camera view provided by the aircraft (e.g., video feeds generated by the cockpit monitoring system 152, aircraft sensor systems 131, and/or exterior vision system 159). When these views are presented on aircraft displays 180 (e.g., such as the windshield display 181, exterior aircraft display 187, flight augmentation display 188, etc.) to a copilot located at the copilot GBS 170, the image recognition software can detect objects presented in aircraft displays 180 and the copilot can select objects of interest. In this scenario, the aforementioned distance measuring functions can output the distance between the aircraft of the selected objects.

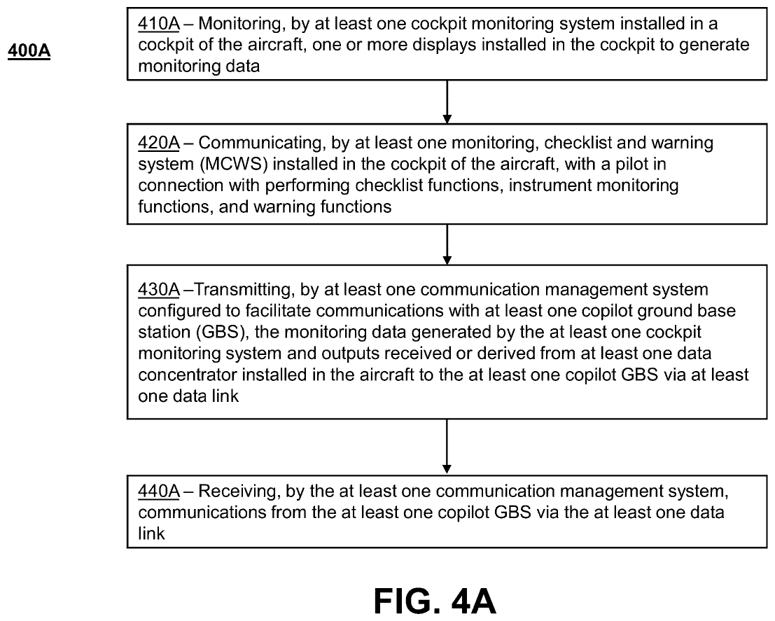

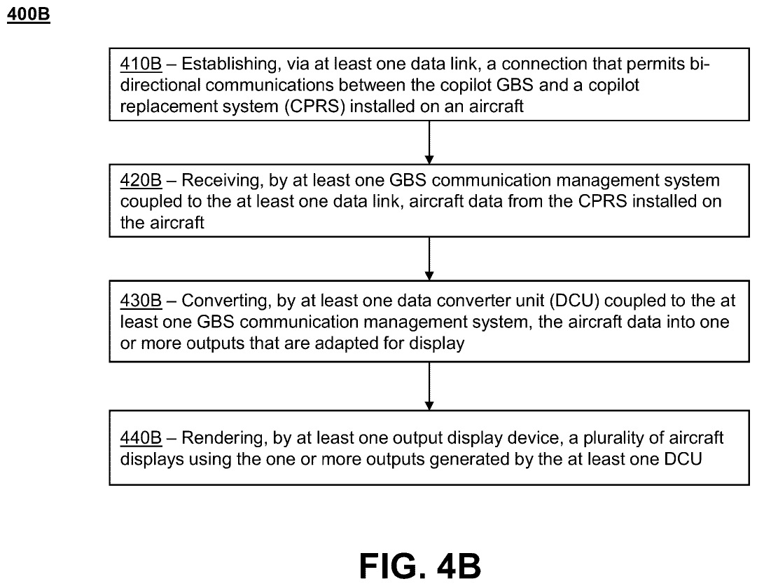

FIG. 4A illustrates a flow chart for an exemplary method 400A for operating a CPRS according to certain embodiments. Method 400A is merely exemplary and is not limited to the embodiments presented herein. Method 400A can be employed in many different embodiments or examples not specifically depicted or described herein. In some embodiments, the steps of method 400A can be performed in the order presented. In other embodiments, the steps of method 400A can be performed in any suitable order. In still other embodiments, one or more of the steps of method 400A can be combined or skipped. In many embodiments, the CPRS 150, aircraft system 100B, system 100A and/or aircraft 105 can be configured to perform method 400A and/or one or more of the steps of method 400A. In these or other embodiments, one or more of the steps of method 400A can be implemented as one or more computer instructions configured to run at one or more processing devices and configured to be stored at one or more non-transitory computer storage devices. Such non-transitory memory storage devices and processing devices can be part of an avionics or aircraft system such as the CPRS 150, aircraft system 100B, system 100A and/or aircraft 105.

In step 410A, at least one cockpit monitoring system installed in a cockpit of the aircraft monitors one or more displays installed in to generate monitoring data.

In step 420A, at least one monitoring, checklist and warning system (MCWS) installed in the cockpit of the aircraft communicates with a pilot in connection with performing checklist functions, instrument monitoring functions, and warning functions.

In step 430A, at least one communication management system configured to facilitate communications with at least one copilot ground base station (GBS) transmits the monitoring data generated by the at least one cockpit monitoring system and outputs received or derived from at least one data concentrator installed in the aircraft to the at least one copilot GBS via at least one data link.

In step 440A, the at least one communication management system receives communications from the at least one copilot GBS via the at least one data link.

In some embodiments, the step of monitoring, by at least one cockpit monitoring system installed in a cockpit of the aircraft, one or more displays can include one or more of the following: generating, by one or more camera devices installed in the cockpit of the aircraft, video data for monitoring one or more instrument panel displays installed in the cockpit of the aircraft; or receiving, by one or more data connections that couple the one or more instrument panel displays to the at least one cockpit monitoring system, outputs generated by the one or more instrument panel displays.

In some embodiments, the MCWS can be configured to autonomously monitor the checklist functions, the instrument monitoring functions, and the warning functions, and autonomously communicate with the pilot in connection with performing the checklist functions, the instrument monitoring functions, and the warning functions.

In some embodiments, the method 400A may further include one or more steps comprising: capturing, by at least one exterior vision system installed on or near an exterior of the aircraft, external vision data; providing the external vision data to the at least one communication management system; and transmitting, by the at least one communication management system, the external vision data captured by the at least one exterior vision system to the at least one copilot GBS via the at least one data link.

In some embodiments, the step of receiving, by the at least one communication management system, communications from the at least one copilot GBS via the at least one data link can include at least two of the following: (i) receiving, via the at least one data link, communications to remotely control or use one or more radio devices installed on the aircraft for communicating with one or more air-based entities or one or more ground-based entities; (ii) receiving, via the at least one data link, communications for remotely interacting with the pilot in connection with performing the checklist functions, the instrument monitoring functions, and the warning functions; (iii) receiving, via the at least one data link, communications for remotely controlling operation of an autopilot system installed in the aircraft; (iv) receiving, via the at least one data link, communications for remotely controlling operation of an autothrust system installed in the aircraft; (v) receiving, via the at least one data link, via the at least one data link, communications for remotely controlling operation of an autoland system installed in the aircraft; (vi) receiving, via the at least one data link, communications for remotely controlling navigation or maneuvers of the aircraft; and (vii) receiving, via the at least one data link, communications for remotely controlling a flight plan or flight path for the aircraft.

In some embodiments, the method 400A may further include a step of receiving, by via one or more onboard controls of the CPRS, a command to override or restrict control of the aircraft by the at least one copilot GBS or other remote entity.

In some embodiments, the method 400A may further include a step of receiving, by at least one data transfer relay installed in the aircraft, one or more control commands from the at least one copilot GBS for manipulating one or more aircraft components located in the aircraft. In some examples, the at least one data transfer relay enables the at least one copilot GBS to manipulate actuation switches or indicators for at least two of: controlling landing gear, flaps, engines, autopilot functions, autothrottle functions, autonomous landing systems, lighting systems, communication systems, fuel selector systems, or electronic circuit breakers.

FIG. 4B illustrates a flow chart for an exemplary method 400B for operating a copilot GBS 170 according to certain embodiments. Method 400B is merely exemplary and is not limited to the embodiments presented herein. Method 400B can be employed in many different embodiments or examples not specifically depicted or described herein. In some embodiments, the steps of method 400B can be performed in the order presented. In other embodiments, the steps of method 400B can be performed in any suitable order. In still other embodiments, one or more of the steps of method 400B can be combined or skipped. In many embodiments, the copilot GBS 170, CPRS 150, aircraft system 100B, system 100A and/or aircraft 105 can be configured to perform method 400A and/or one or more of the steps of method 400A. In these or other embodiments, one or more of the steps of method 400B can be implemented as one or more computer instructions configured to run at one or more processing devices and configured to be stored at one or more non-transitory computer storage devices. Such non-transitory memory storage devices and processing devices can be part of a computing system such as the copilot GBS 170, CPRS 150, aircraft system 100B, system 100A and/or aircraft 105.

In step 410B, a connection is established via at least one data link that permits bi-directional communications between the copilot GBS 170 and a CPRS 150 installed on an aircraft 105.

In step 420B, aircraft data from the CPRS 150 installed on the aircraft 105 is received by at least one GBS communication management system 174 coupled to the at least one data link.

In step 430B, the aircraft data is converted by at least one DCU 173 coupled to the at least one GBS communication management system 174 into one or more outputs that are adapted for display.

In step 440B, a plurality of aircraft displays 180 are rendered on at least one output display device 172 using the one or more outputs generated by the at least one DCU.

In certain embodiments, the connection established between the copilot GBS 170 and the CPRS 150 installed on the aircraft enables a ground-based pilot to remotely monitor operations of the aircraft on the at least one output display device 172, communicate with an onboard pilot located in a cockpit of the aircraft, and/or transmit commands for controlling one or more functionalities of the aircraft.

In some embodiments, the method 400B may further include one or more steps comprising: presenting, by the at least one display device of the copilot GBS, a simulated MCDU interface that is configured to display feedback related to the aircraft's operations and receive inputs from the ground-based pilot for controlling the aircraft's operation; and transmitting, based on the inputs received via the simulated MCDU interface, one or more commands over the at least one data link for adjusting settings of a flight management system (FMS) or a flight guidance computer (FGC) installed on the aircraft.

In some embodiments, the method 400B may further include one or more steps comprising: receiving, via the at least one data link installed at the copilot GBS, monitoring data generated by a cockpit monitoring system installed on the aircraft; rendering, by the at least one output display device, one or more aircraft displays that comprises the monitoring data; receiving, via the at least one data link installed at the copilot GBS, outputs generated by, or derived from, at least one data concentrator installed on the aircraft; generating, by the at least one output display device, one or more aircraft displays based, at least in part, on the outputs generated by, or derived from, at least one data concentrator installed on the aircraft; receiving, via the at least one data link installed at the copilot GBS, external vision data captured by at least one exterior vision system installed on or near an exterior of the aircraft; and rendering, by the at least one output display device, one or more aircraft displays that comprises the external vision data.

In some embodiments, the method 400B may further include one or more steps comprising: receiving, via the at least one data link installed at the copilot GBS, data from a monitoring, checklist and warning system (MCWS) installed in the cockpit of the aircraft; and transmitting, via the at least one data link installed at the copilot GBS, commands to the aircraft that enable the ground-based pilot to remotely interact with the MCWS on the aircraft for performing checklist functions, instrument monitoring functions, and warning functions.

In some embodiments, the method 400B may further include one or more steps comprising: transmitting, via the at least one data link, commands to remotely control or use one or more radio devices installed on the aircraft for communicating with one or more air-based entities or one or more ground-based entities; transmitting, via the at least one data link, commands for remotely controlling operation of an autopilot system installed in the aircraft; transmitting, via the at least one data link, commands for remotely controlling operation of an autothrust system installed in the aircraft; transmitting, via the at least one data link, commands for remotely controlling operation of an autoland system installed in the aircraft; transmitting, via the at least one data link, commands for remotely controlling navigation or maneuvers of the aircraft; and/or transmitting, via the at least one data link, commands for remotely controlling a flight plan or flight path for the aircraft.

In some embodiments, the method 400B may further include one or more steps comprising: receiving, via the at least one data link, external vision data captured by an external vision system installed on the aircraft; and rendering, by the at least one output display device, a flight augmentation display based, at least in part, on external vision data, wherein the flight augmentation display augments the external vision data with overlays or objects that provide information for assisting the ground-based pilot with landing the aircraft.

In some embodiments, the method 400B may further include the step of comprising terminating the connection between the copilot GBS and the aircraft in response to an override command.

The functionalities of the CPRS may eliminate the need for a copilot to be located onboard an aircraft 105, and can reduce the burden or workload of an onboard pilot with respect to operating the aircraft by connecting one or more remotely situated copilots who can assist with the onboard pilot in various ways (e.g., by performing and executing checklists and callouts, monitoring instruments, controlling operation of the aircraft, etc.). In certain embodiments, the aircraft 105 also can be equipped with an AI (artificial intelligence) control system 550 that serves as an additional source of assistance and further reduces the workload or burden of the onboard pilot and/or remote copilot by autonomously evaluating situational or operational parameters and executing actions to control operation of the aircraft 105. The combination of the CPRS 150 and AI control system 550 enables an onboard pilot to leverage assistance from two different sources in operating the aircraft 105. The AI control system 550 also can aid a remotely connected copilot in performing various functions as well.

In certain embodiments, the AI control system 550 can be installed in the aircraft itself 105. Additionally, or alternatively, the AI control system 550, or certain portions thereof, can be installed at a copilot GBS 170. In certain embodiments, the CPRS 150 be integrated as a component of the CPRS 150. Additionally, or alternatively, the AI control system 550 can be a standalone component that is separate from the CPRS 150, and which is in communication with the CPRS 150.

In certain embodiments, the AI control system 550 can include one or more computer vision systems 510, one or more natural language processing (NLP) systems 520, and one or more autonomous controllers 530. The AI control system 550 also may include other types of learning models or algorithms as well. Further details regarding how these learning models and algorithms can be leveraged to assist pilots with controlling or operating an aircraft are described below.

The AI control system 550, computer vision system 510, NLP system 520, and/or autonomous controller 530 can be in bidirectional communication with any system or component installed in the aircraft 105 and/or installed in a copilot GBS 170 connected to the aircraft 105 (including, but not limited to, any of the components illustrated in FIGS. 1B, 3A, and 3B). That is, the AI control system 550, computer vision system 510, NLP system 520, and/or autonomous controller 530 can receive any data generated by each of these components, and can send data or signals to each of these components (e.g., in connection with monitoring, manipulating, or controlling the components).

The AI control system 550 that can be configured to leverage various AI or machine learning frameworks to analyze operational parameters of the aircraft 105 (and an environment in which the aircraft 105 operates) and/or to undertake automatic decision-making and action implementation to assist an onboard pilot and/or remote copilot with operating the aircraft 105.

The AI control system 550 can be configured to implement varying levels of flight automation. Varying levels of flight automation may be provided as set forth below.
Level 1A (Human Augmentation): Decisions can be taken by the onboard and/or ground pilot based on support provided by the AI control system 550. All actions are implemented by either the onboard pilot or ground pilot. The involvement of the AI control system 550 can range from organization of incoming information according to some criteria to prediction (e.g., using by interpolation and/or extrapolation techniques) or integration of the information for the purpose of augmenting perception and cognition of the onboard or ground pilot.
Level 1B (Human cognitive assistance in decision and action selection): Decisions can be taken by the onboard pilot and/or ground pilot based on support by the AI control system 550. All actions are implemented by either the onboard pilot or ground pilot. This level adds the step of support to decision-making by the onboard pilot or ground pilot by presenting the pilots with options to choose from and, therefore, assisting in the process of selection of a course of action among several possible alternative options.
Level 2A (Human and AI-based system cooperation): The onboard pilot or ground pilot/AI teaming concept foresees a partial release of authority to the AI control system 550 however under full oversight of the onboard pilot and/or ground pilot, who consistently remain accountable for the operations. The implementation of AI automatic decisions or actions are fully monitored and can be overridden by the onboard pilot or the ground pilot. For example, the onboard or ground pilot could decide to execute a go around despite a decision from the AI control system to proceed with an autoland. Level 2A also addresses the automatic implementation of certain courses of action by the AI control system 550 even when the decision is taken by the onboard or ground pilot. For example, the AI control system 550 could assist by supporting automatic aircraft approach configuration prior to landing.
Level 2B (Human and AI-based system collaboration): The onboard pilot or ground pilot/AI teaming concept foresees a partial release of authority to the AI control system 550 under full oversight of the onboard or ground pilot, who consistently remain accountable for the operations. Level 2B permits the AI control system 550 to take over some authority on decision-making, share situation awareness, and re-adjust task allocation in real time. The AI control system 550 and the onboard/ground pilots share tasks and have a common set of goals under a collaboration scheme. The AI control system 550 has the capability to use natural language for communication with the pilots, allowing an efficient bilateral communication between the AI control system 550 and the flying or ground pilots.
Level 3 (Full AI Autonomy): The AI control system 550 is generally free to take over decision-making and control of the aircraft. However, the onboard pilot and/or ground pilot can still override decisions and actions undertaken by the AI control system 550.

While certain embodiments may describe the AI control system 550 as being configured with functionalities to implement autonomous flight controls up to and including Level 2B, it should be understood that the AI control system 550 can be adapted to implement autonomous flight controls up to any desired level, and the same techniques described in this disclosure can be applied to the AI control system 550 when it is configured to implement any level of automation. Depending on the desired level of autonomy, the AI control system 550 may autonomously perform all actions or activities that could be performed traditionally by a pilot and/or copilot (e.g., such as scheduling, modifying, and executing flight plans, executing checklist functions, monitoring flight systems and warning indicators, executing aircraft maneuvers, landing the aircraft, tuning radio or communication devices, communicating with the air traffic control and/or other aircraft, controlling autopilot, autothrust, and/or autoland functions, etc.). In many preferred embodiments, the onboard pilot and/or ground-based pilot can utilize override controls 540 to override, cancel, or modify decisions or actions of the AI control system 550. Additionally, the AI control system 550 can be utilized to analyze an operational state of the aircraft and/or take actions during any or all phases of flight (e.g., pre-flight, pushback and taxi, takeoff, climb, cruise, descent, approach, landing. taxi to the gate, shutdown and de-boarding, etc.) to aid an onboard pilot and/or remote copilot with operating an aircraft or performing related functions.

In certain embodiments, the AI control system 550 can be configured with varying levels of automation and/or can be dynamically allocated permissions according to different automation levels based on situational parameters or circumstances. In certain scenarios, an aircraft 105 can be configured with combination of the above-mentioned automation levels to ensure a complete fail-safe system, whereby different levels of automation can be applied or utilized based on the criticality and/or phase of flight. For example, the ability for the AI control system 550 to detect a suitable landing site in case of an emergency may be limited to Level 2A. However, in the situation where the onboard pilot is incapacitated (possibly combined with a failure that requires immediate landing and the ground pilot has lost high speed communications), the AI control system 550 can be allocated autonomous control up to Level 2B, thereby enabling the AI control system 550 to take the necessary actions to ensure the safeguard of the aircraft and passengers, such as by landing the aircraft on the determined landing site. In this exemplary scenario, the ground pilot may have the option to override that decision in time utilizing the low-speed backup communication system (e.g., a redundant system that becomes available to the ground-based pilot after the primary high-speed data link becomes unavailable). Varying levels of automation may be allocated to the AI control system 550 in other scenarios as well.

The disclosure below illustrates exemplary implementations and configurations of the computer vision 510, NLP system 520, and autonomous controller 530 that can be configured with varying levels of control.

The computer vision system 510 can be configured to perform exterior monitoring functions 511 associated with monitoring the exterior environment of the aircraft 105. The computer vision system 510 also can be configured to perform interior monitoring functions 511 associated with monitoring the activities, instructions, or displays in the cockpit and/or monitoring other interior portions within the aircraft 105 (e.g., such as the EE bay 120, passenger cabins, and/or cargo storage cabins).

The computer vision system 510 may receive visual or imaging data from various sources, such as any camera systems, infrared cameras, LIDAR systems, and/or millimeter-wave radar of the exterior vision systems 159. In certain embodiments, the computer vision system 510 also may receive visual or imaging data from other sources outside the aircraft 105, such as camera systems and/or LIDAR systems installed near runways, at airports, and/or on other aircraft 105.

The exterior monitoring functions 511 may be configured to enhance situational awareness and safety during aircraft operations in various ways. In some embodiments, the exterior monitoring functions 511 may analyze visual data from some or all of the aforementioned sources to detect and track other aircraft in the vicinity, permitting the pilot and/or autonomous controller 530 to prevent potential collisions or airspace conflicts. The exterior monitoring functions 511 may be used to identify and monitor weather conditions, such as storm systems, turbulence, or icing conditions, allowing the pilot and/or autonomous controller 530 to make informed decisions about flight paths and altitudes. In some cases, the exterior monitoring functions 511 may assist in runway condition assessment during takeoff and landing, detecting obstacles, debris, or wildlife that could pose hazards. In some scenarios, the external monitoring functions 511 also may be configured to detect, evaluate, and/or identify unapproved landing surfaces on the ground, which may be utilized to land the aircraft 105 in the case of an emergency. Additionally, the exterior monitoring functions 511 may aid in terrain awareness, providing visual cues about surrounding landscape features, particularly useful during low-visibility conditions or in unfamiliar environments. The exterior monitoring functions 511 may also contribute to aircraft system monitoring, such as observing engine exhaust patterns or checking for any visible damage to the aircraft's exterior during flight. The exterior monitoring functions 511 performed by the computer vision 510 can be applied to analyze many other visual conditions useful for operating the aircraft 105.

The interior monitoring functions 512 may receive visual or imaging data from various sources within the aircraft. In some embodiments, these functions may utilize data from cameras or sensors installed in the cockpit, such as those that are part of the cockpit monitoring system 152. Additionally, the interior monitoring functions 512 may receive visual data from cameras positioned in other areas of the aircraft, including passenger cabins, cargo holds, and/or EE bays.

The interior monitoring functions 512 may analyze the visual data to perform various tasks related to aircraft operation and safety. For example, in the cockpit, the interior monitoring functions 511 may assess instrument panels, displays, and controls to detect any abnormal readings or settings. In passenger areas, these functions may be used to identify potential security threats or medical emergencies. The interior monitoring functions 512 may also analyze cargo areas to detect any unintended movement or shifting of payload during flight. In the EE bay, these functions may be employed to monitor critical systems for signs of malfunction or overheating. The interior monitoring functions 512 performed by the computer vision 510 can be applied to analyze many other visual conditions as well.

The computer vision system 510 can communicate or interface with the autonomous controller 430. Any or all of the aforementioned analysis information (and/or other types of analysis information) generated by the computer vision system 510 can be provided to the autonomous controller 530 to aid it in understanding operational conditions, making decisions, and/or implementing actions associated with operating the aircraft.

The configuration of the computer vision system 510 can vary. In some examples, the computer vision system 510 may include a neural network or deep learning architecture that that includes one or more convolution neural networks (CNNs). Each CNN may include a plurality of layers including, but not limited to, one or more input layers, one or more output layers, one or more convolutional layers (e.g., that include learnable filters), one or more ReLU (rectifier linear unit) layers, one or more pooling layers, one or more fully connected layers, one or more normalization layers, etc. The configuration of the CNNs and their corresponding layers can be configured to enable the CNNs to learn and execute various functions for analyzing, interpreting, and understanding the images, including any of the functions described in this disclosure.

Regardless of its configuration, the computer vision system 510 can be trained to execute various computer vision functions. For example, in some cases, the computer vision system 510 can execute object detection functions, which may include predicting or identifying locations of objects (e.g., using bounding boxes) associated with one or more target classes in the images. Additionally, or alternatively, the computer vision system 510 can execute object classification functions (e.g., which may include predicting or determining whether objects in the images belong to one or more target semantic classes and/or predicting or determining labels for the objects in the images) and/or instance segmentation functions (e.g., which may include predicting or identifying precise locations of objects in the images with pixel-level accuracy). In the context of this disclosure, these computer vision functions (e.g., such as object detection, classification, and segmentation) may be fine-tuned or configured specifically for aircraft environments (e.g., such as to perform functions such as ascertaining readings presented on instrument panels, detecting and classifying objects located in or near the aircraft's flight path or environment, identifying hazards, fires, or smoking of aircraft components, etc.). The computer vision system 510 can be trained to perform other types of computer vision functions as well.

In some embodiments, the computer vision system 510 can be configured to extract feature representations from images, video, or visual data input to the system. The feature representations may represent embeddings, encodings, vectors, features, and/or the like, and each feature representation may include encoded data that represents and/or identifies one or more objects included in an image. In some embodiments, the computer vision system 510 also can be trained to utilize the object representations to execute one or more computer vision functions (e.g., object detection, object classification, and/or instance segmentation functions).

In certain embodiments, one or more training procedures may be executed to train the computer vision system 510 to perform the computer vision functions described in this disclosure. Amongst other things, the training procedures can enable the computer vision system 510 to learn functions for identifying different types of objects and/or environments that can affect the safety or operation of the aircraft 105. The specific procedures that are utilized to train the computer vision system 510 can vary. In some cases, one more supervised training procedures, one or more unsupervised training procedures, and/or one or more semi-supervised training procedures may be applied to train the computer vision system 510. In some embodiments, a supervised training procedure can be applied that utilizes labeled objects or images that are annotated with semantic labels to enable the computer vision system 510 to identify objects, conditions, and/or environments that can affect the safety or operation of the aircraft 105.

The visual content provided as an input to the computer vision system 510 can include various types of objects, and the computer vision system 510 may execute objection detection and/or classification functions to identify and classify the objects. The computer vision system 510 (including the exterior monitoring functions 511 and interior monitoring functions 512) can be configured to identify and classify various the types of objects included in the visual content, such as those corresponding to other aircraft (e.g., airplanes, helicopters, etc.), birds, weather conditions (e.g., clouds, storms, rain, snow, hail, etc.), aircraft hazards (e.g., fires, smoke, damaged aircraft components or equipment, etc.), persons (e.g., passengers, flight attendants, etc.), weapons (e.g., such as guns, knives, etc.), and aircraft equipment, devices, and components (e.g., such as components installed in the cockpit 110 and/or EE bay 120).

The computer vision system 510 can be configured to generate and output analysis information based on an analysis of the visual content fed into the system. The analysis information for an image can generally include any information or data associated with analyzing, interpreting, understanding, and/or classifying the images and the objects included in the images. Additionally, or alternatively, the analysis information can include information or data that indicates the results of the computer vision functions performed by the neural network architecture. For example, the analysis information may include the predictions and/or results associated with detecting obstacles in or near the aircraft's flight path, detecting adverse weather conditions in or near the aircraft's flight path, detecting aircraft components (e.g., engines) that have been damaged (e.g., which are smoking or on fire) or which are malfunctioning, etc.

Any analysis information generated by the computer vision system 510 can be output (e.g., via a cockpit display or speaker) to notify the onboard pilot and/or remote copilot of conditions relating to the aircraft and/or its operation. Additionally, the analysis information also may be provided to the autonomous controller 530 to enable the autonomous controller 530 to make decisions and execute actions for controlling the aircraft 105.

The NLP system 520 can generally perform operations associated with analyzing text, video, and/or audio inputs. In certain embodiments, the NLP system 520 can be configured to execute operator communication functions 521 and/or radio monitoring functions 523.

The operator communication functions 521 can enable an onboard and/or remote copilot to interact and communicate with the AI control system 550. In some examples, the operator communication functions 521 may be configured to interpret commands, instructions, and queries received from the pilots, and to generate outputs for responding to the pilots.

Additionally, the operator communication functions 521 also can be configured to preemptively communicate with the pilots, such as to notify the pilots of relevant issues that are detected by the AI control system 550 and/or other aircraft systems. In some scenarios, the operator communication functions 521 may notify pilots about aircraft parameters, operational conditions, and/or other situational awareness issues. In some examples, the operator communication functions 521 may alert pilots to abnormal instrument readings, equipment malfunctions, detected obstacles, adverse weather conditions, medical emergencies detected in passenger cabins, equipment that is damaged, etc.

In some embodiments, the NLP system 520 may communicate directly or indirectly with the computer vision system 510, and may receive analysis information generated by the computer vision system 510 or derived from outputs of the computer vision system 510. The NLP system 520 may utilize this analysis information to notify the pilots (both the onboard and/or remote copilot) about issues or conditions detected by the computer vision system 510.

Additionally, the operator communication functions 521 also may inform pilots about actions that the autonomous controller 530 has taken or intends to take. In certain embodiments, these operator communication functions 521 may execute verification functions 522, which may solicit confirmations from pilots before or shortly after the autonomous controller 530 executes certain actions (e.g., such as adjusting the flight plan or activating aircraft equipment or systems).

For example, in response to the autonomous controller 522 determining that a particular action should be undertaken (e.g., such as changing the aircraft's flight path, executing a maneuver, activating/deactivating certain equipment, etc.), the autonomous controller 522 may communicate the intended action to the NLP system 520 and the NLP system 520 may execute a verification function 522 which notifies the pilot or remote copilot of the intended action and requests approval for executing the action. In response, the pilot or copilot may issue a command (e.g., either verbally via a microphone or by selecting an option on display) to confirm the intended action is acceptable, to deny approval of the intended action, and/or to modify the action. The command issued by the onboard pilot or remote copilot may be interpreted by the NLP system 520, and the NLP system 520 may relay the command to the autonomous controller 530 confirming, denying, or modifying the intended action. In other examples, after the autonomous controller 522 initiates an action, the NLP system 520 may execute a verification function 522 that notifies the onboard pilot and/or remote copilot of the initiated action, and which request verification or confirmation that the action is appropriate and/or which requests instructions for cancelling, denying, or modifying the action.

In this manner, the operator communication functions 521 may provide one mechanism for implementing of AI override controls 540, allowing pilots to countermand decisions or actions initiated by the autonomous controller 530 if desired. As explained below, the AI override controls 540 can be implemented in other ways as well.

The NLP system 520 may be configured to facilitate communication between the onboard pilot, remote pilot, and the AI control system 550 through various input and output modalities. In some embodiments, the pilots may interact with the NLP system 520 using voice commands, which may be processed using voice-to-text translation capabilities. This may allow for hands-free operation and natural language interactions. Additionally, the NLP system 520 may receive inputs via touchscreen interfaces, physical keyboards, physical buttons or switches, and/or other input means. These input methods may enable pilots to issue commands, make queries, and/or provide information to the AI control system 550. The NLP system 520 may interpret these inputs, process them accordingly, and generate appropriate responses or actions based on the pilots'instructions. AIong similar lines, the NLP system 520 can output information to the pilots using various output means, such as via by providing auditory feedback via speaker devices and/or visual feedback via display screens or touchscreens.

The NLP system 520 also may be configured to execute radio monitoring functions 523. The radio monitoring functions 523 may be configured to analyze and interpret communications from various radio sources, including air traffic controllers, other aircraft, and ground stations. These functions may utilize audio-to-text or speech-to-text conversion capabilities to initially process voice communications, enabling the NLP system 520 to extract relevant information and context from radio transmissions.

In some examples, the radio monitoring functions 523 can monitor communications from air traffic controllers in various ways. The radio monitoring functions 523 may utilize audio-to-text conversion capabilities to process voice communications received from air traffic controllers. This converted text can then be analyzed using natural language processing techniques to extract relevant information and instructions.

In some embodiments, the radio monitoring functions 523 may be able to identify and categorize different types of air traffic control communications, such as clearances, weather updates, traffic advisories, or emergency instructions. This categorization may help prioritize information for the pilots and autonomous systems. Additionally, the radio monitoring functions 523 may be capable of parsing air traffic control instructions to extract specific directives, such as altitude changes, heading adjustments, speed modifications, or approach clearances. This parsed information can be utilized to communicate with the onboard pilot and remote copilot and/or used by the autonomous controller 530 to take appropriate actions based on the communications. The radio monitoring functions 523 may also be configured to detect and flag any unusual or emergency communications from air traffic controllers, alerting the pilots and autonomous controller 530 to potential critical situations. In further examples, the radio monitoring functions 523 may maintain a log of air traffic control communications, allowing for later review or analysis if needed.

In certain embodiments, some or all of the analysis information generated by the radio monitoring functions 523 and/or NLP system 520 may be provided to the autonomous controller 530, to enable the autonomous controller 530 to make decisions and/or execute actions for controlling or manipulating the aircraft 105. In one example, the autonomous controller 530 may utilize the analysis information generated by the NLP system 520 to cross-reference air traffic control communications with the aircraft's current flight plan and parameters, which can permit the autonomous controller 530 to identify any discrepancies or conflicts between instructions and the planned route and, if needed, take corrective actions. In other examples, the autonomous controller 530 may utilize the analysis information generated by the NLP system 520 during landing or approach phases to determine whether to adjust angles of attack, abort a current landing approach, and/or make another pass. In further examples, the autonomous controller 530 may automatically adjust a flight path, altitude, direction, or parameter of the aircraft 105 in response to the NLP system 520 detecting instructions from air traffic controllers or other radio sources.

In some examples, the radio monitoring functions 523 can monitor communications from other aircraft for various purposes. The system may utilize audio-to-text or speech-to-text conversion capabilities to process voice communications received from other aircraft, converting verbal communications into text for further analysis by the NLP system 520. In certain implementations, the system may be able to correlate communications from other aircraft with data from the aircraft's own sensors and systems to build a more comprehensive picture of the surrounding airspace.

In some examples, the radio monitoring functions 523 may be able to identify and categorize different types of aircraft-to-aircraft communications, such as position reports, traffic alerts, or weather observations. Additionally, the radio monitoring functions 523 may be capable of parsing communications from other aircraft to extract specific information, such as altitude, heading, speed, or intentions. The radio monitoring functions 523 also may be configured to detect and flag any unusual or emergency communications from other aircraft, alerting the pilots and autonomous systems to potential critical situations in the vicinity. In further examples, the NLP system 520 may be able to maintain a log of communications from other aircraft, allowing for later review or analysis if desired. In further examples, the NLP system 520 may automatically respond to communications from other aircraft or traffic controllers, and/or preemptively initiate communications with other aircraft or traffic controllers, and these responses and communications can be transmitted to other aircraft or traffic controllers over radio channels. This analysis information generated by the NLP system 520 can be used to enhance situational awareness for the onboard pilot, remote copilot, and autonomous controller 530.

The radio monitoring functions 523 may be designed to handle communications in various formats, including standard radio transmissions and digital communications such as ADS-B (Automatic Dependent Surveillance-Broadcast) messages. The system may be capable of processing communications from multiple aircraft simultaneously, helping to build a real-time understanding of traffic in the surrounding airspace.

The NLP system 520 may be configured to process and utilize information from Automatic Dependent Surveillance-Broadcast (ADS-B) systems for various purposes. ADS-B broadcasts may provide real-time data about nearby aircraft, including their position, altitude, velocity, and identification. In some embodiments, the NLP system 520 may interpret textual or encoded ADS-B messages, extracting relevant information to enhance situational awareness. The autonomous controller 530 may incorporate this ADS-B data into its decision-making processes, potentially using it to adjust flight paths, maintain safe separation from other aircraft, or optimize routing. In certain implementations, the system may fuse ADS-B information with data from other sources, such as onboard sensors or air traffic control communications, to create a more comprehensive understanding of the airspace environment. This integration of ADS-B data may enable more informed and proactive decision-making by both the AI systems and human pilots, improving overall flight safety and efficiency.

Additionally, the radio monitoring functions 523 also may be designed to handle concurrent communications, such as when multiple air traffic controllers and/or aircraft are providing information or instructions simultaneously. While human pilots may not be capable of simultaneously processing multiple communications received from different sources at one time, the radio monitoring functions 523 can process simultaneous communications and can subsequently relay this information to the pilot, remote copilot, and/or autonomous controller 530 to ensure all communications are properly received and evaluated in making decisions with regard to operating the aircraft 105.

Additionally, the radio monitoring functions 523 may be able to adapt to different human languages, phraseologies, and communication styles used by pilots from various regions or countries. For example, the pilot or remote copilot may not speak a language of a pilot located on a nearby aircraft, and the NLP system 520 may be applied to perform language translation to enable the pilots to understand the foreign language. The same language translation capabilities also can be applied to communications received from air traffic controllers and/or other entities.

Any analysis information generated by the NLP system 520 (including in connection with performing the operator communications functions 521 and/or radio monitoring functions 522) can be output to notify the onboard pilot and/or remote copilot of conditions relating to the aircraft and/or its operational environment. Additionally, the analysis information also may be provided to the autonomous controller 530 to enable the autonomous controller 530 to make decisions and execute actions for controlling the aircraft 105.

The NLP system 520 may be implemented using various types of natural language processing models and architectures. In some embodiments, the NLP system 520 may utilize large language models (LLMs) that have been trained on vast amounts of text data to understand and generate human-like text. These LLMs may include comprehensive language understanding and generation capabilities utilized in executing the operator communication functions 521 and radio monitoring functions 523. In certain implementations, the NLP system 520 may incorporate one or more generative pretrained transformer (GPT) models, one or more BERT (Bidirectional Encoder Representations from Transformers) models and/or other types of language models or architectures. Regardless of which learning model(s) is utilized to implement the functionalities of the NLP system 520, the deployed model may be fine-tuned for specific aviation-related tasks such as interpreting pilot commands or analyzing air traffic control communications. Additionally, in some cases, the NLP system 520 may utilize a combination of different model architectures, potentially including custom models trained specifically on aviation-related datasets, to optimize performance across various language processing tasks for aircraft operations. Any appropriate training technique may be applied to train the NLP system, including supervised, unsupervised, and/or semi-supervised training techniques.

The autonomous controller 530 can be configured to execute various functions associated with monitoring or analyzing the aircraft 105 and its operational environment, and executing actions for controlling operation of the aircraft 105 and/or the subsystems or components of the aircraft. The autonomous controller 530 may receive and utilize data from various sources, such as the computer vision 510, NLP 520, and/or components 111-113, 121-125, 131, 151-159, in performing these functions.

The configuration or implementation of the autonomous controller 530 can vary. In some embodiments, the autonomous controller 530 may utilize programmatic logic to make decisions and execute action based on analysis information received from the computer vision system 510 and NLP system 520, as well as inputs received directed from aircraft avionics, components, or sensors (e.g., such as the components illustrated in FIG. 1B). Additionally, or alternatively, the autonomous controller 530 may include one or more learning models that aid the autonomous controller 530 in making decisions and executing actions. For example, in some embodiments, the autonomous controller 530 can utilize a reinforcement learning model, decision-making algorithm, optimization algorithm, and/or other machine-learning based frameworks to aid it making decision and determining whether to execute various actions.

Regardless of its implementation, the autonomous controller 530 can be configured to execute operational assessment functions 531 that enable the autonomous controller 530 to understand an operating state of the aircraft 105 and its surrounding environment. In some examples, the operational assessment functions 531 may utilize inputs from various sources (e.g., such as the computer vision system 510, NLP system 520, and/or aircraft components and subsystems) to interpret, understand, and/or evaluate an exterior environment of the aircraft (e.g., such as those relating to weather conditions or external obstacles). In other examples, the operational assessment functions 531 also may utilize inputs from these sources to interpret, understand, and/or evaluate conditions of the aircraft or its operation (e.g., such as whether the aircraft's sensors, subsystems, or components are operating properly, whether the aircraft's flight path can be optimized, whether the aircraft actual flight path matches a target or desired flight path, etc.). In further examples, the operational assessment functions 531 may further utilize inputs from these sources to interpret, understand, and/or evaluate interior conditions within the aircraft (e.g., whether the hostile individuals or medical emergencies are detected in the passenger cabin, whether unusual activities are detected in cargo bays, whether breathing apparatuses have been deployed, whether certain equipment is damaged, etc.). Some or all of the aforementioned aspects may be utilized by the operational assessment functions 531 to understand or derive an operational state 531A of the aircraft 105.

The operational assessment functions 531 can facilitate situational awareness by interpreting and understanding a wide variety of parameters relating to the aircraft 105 and the environment in which it operates. Amongst other things, the operational assessment functions 531 can enable the AI control system 510 to ascertain a comprehensive operational state 531A of the aircraft 105, which considers the various contextual parameters such as the status or health of the aircraft components and subsystems, the current flight plan of the aircraft, the current flight parameters (e.g., speed, altitude, phase of flight, etc.) of the aircraft, communications received from various sources (e.g., other aircraft and/or air traffic controllers), analysis information generated by the computer vision system 510, analysis information generated by the NLP system 520, commands or instructions received from pilots (e.g., both onboard pilots and/or remote copilots), and/or other contextual factors related to operating the aircraft 105. The AI control system 550 can utilize the operational state 531A of the aircraft to autonomously execute a variety of actions in connection with operating or controlling the aircraft 105.

The decision-making functions 532 executed by the autonomous controller 530 can be configured to determine whether or not to execute actions based on the operational state 531A of the aircraft and/or parameters ascertained by the operational assessment functions 531. The types of actions that can be implemented by the decision-making functions 532 can vary greatly based on the current situational conditions and/or the current operational state 531A of the aircraft 105.

In some examples, the decision-making functions 532 may undertake actions for modifying the aircraft's flight path or altitude in response to the computer vision system 510 detecting obstacles and/or adverse weather conditions. In other examples, the decision-making functions 532 may deactivate a specific aircraft component (e.g., an engine, camera, sensor, etc.) in response to detecting a malfunction or hazardous condition associated with the component (and/or may activate a redundant component to replace a non-functional, damaged, or malfunctioning component). In further examples, the decision-making functions 532 may automatically change the flight path or execute a maneuver in response to the NLP system 520 detecting instructions from an air traffic controller over radio transmissions and/or in response to detecting positions of other aircraft via ADS-B communications. In further examples, the decision-making functions 532 may automatically cancel a landing approach in response to detecting obstacles on a runway and/or in response to instructions received from an air traffic controller. In further examples, the decision-making functions 532 may automatically execute autopilot and/or autoland functions in response to detecting that an onboard pilot has become incapacitated. The decision-making functions 532 can be configured to make decisions and execute actions based on many other conditions as well. In some cases, the level of autonomy afforded to the decision-making functions 532 and/or autonomous controller 530 can be aligned with Level 2B described above (or any other desired level). In some cases, the level of autonomy afforded to the decision-making functions 532 and/or autonomous controller 530 can be changed (e.g., increased or decreased) based on the operational state 531A of the aircraft 105 (e.g., based on whether critical conditions are detected, phases of flight, and/or other parameters).

The onboard pilot and/or remote copilot may be provided with access to override controls 540, which enable the onboard pilot and/or remote copilot to override, cancel, and/or modify any action taken by the autonomous controller 530 and/or AI control system 550. The override controls 540 can be implemented in various ways and/or through various modalities.

In some embodiments, the override controls 540 may be implemented through various mechanisms to provide flexibility and redundancy in overriding actions undertaken by the autonomous controller 530. In some examples, the override controls 540 may include voice-based override commands that can be spoken by the onboard pilot and/or remote pilot. These voice commands may be interpreted by the NLP system 520, which can process and relay the override instructions to the appropriate systems for negating or cancelling actions undertaken by the AI control system 550. Additionally, the override controls 540 may be presented as interactive options on displays within the cockpit and/or at the copilot GBS. These display-based controls may allow pilots to select and activate override functions through touchscreen interfaces or cursor control devices. Furthermore, the override controls 540 may include physical controls, such as dedicated buttons, switches, or levers, placed within reach of the onboard pilot and/or remote copilot. In some cases, the override controls 540 may utilize a combination of these implementations, allowing onboard pilots and/or remote pilots to choose the most suitable method based on the specific circumstances or personal preferences.

FIG. 5B illustrates an exemplary configuration for integrating an AI control system into aircraft 105 according to certain embodiments.

In this exemplary configuration, the computer vision system 510 is directly or indirectly coupled with, and receives data from, the exterior vision system 159 and cockpit monitoring system 152. The computer vision system 510 may process and execute various analysis functions (e.g., object detection, classification, segmentation, etc.) on the visual data received from these systems. In some examples, the analysis information may identify detected air-based obstacles (e.g., other aircraft, birds, etc.), ground-based obstacles (e.g., deer, vehicles, or objects located on a runway or landing surface), weather conditions, abnormal instrument readings, unusual passenger activities, movements of cargo, etc.

The computer vision system 510 also is in communication with the NLP system 520 and autonomous controller 530. The visual analysis information generated by the computer vision system 510 may be provided to the NLP system 520 to enable the NLP system 520 to communicate relevant information to the onboard pilot and/or remote pilot via one or more communication interfaces 560 (e.g., via speakers, visual displays, etc.). The analysis information generated by the computer vision system 510 also may be provided to the autonomous controller 530, which may utilize the information to gain a better understanding of the operational state 531A of the aircraft and/or to autonomously execute actions for controlling the aircraft 105.

The NLP system 520 is directly or indirectly coupled with, and receives data from, various radio devices 125A (e.g., which may include multimode radio devices 125) installed on the aircraft 105. The NLP system 520 may process and execute various analysis functions on radio communications received from other aircraft 105B, air traffic controllers 562, and/or copilot GBSs 170. In some examples, the NLP system 520 may extract information relating to flight paths, altitude changes, weather conditions, traffic advisories, emergency situations, runway conditions, clearance instructions, position reports, speed adjustments, holding patterns, approach procedures, and potential conflicts with other aircraft from radio communications received from other aircraft or air traffic controllers.

The NLP system 520 also is directly or indirectly coupled with, and receives data from, one or more ADS-B systems 580 included on the aircraft 105. The NLP system 520 may process and execute various analysis functions on communications sent or received by the ADS-B systems 580. In some examples, the NLP system 520 may process and analyze ADS-B communications to extract information such as aircraft identification, position, altitude, velocity, heading, vertical rate, intent data, emergency status, and weather observations from nearby aircraft.

The NLP system 520 also is directly or indirectly coupled with one or more communication interfaces 560, which serve as an interface between the AI control system 550 and pilots (e.g., including both an onboard pilot 560A and/or remote copilot 560B). The communication interfaces 560 may include various input devices (e.g., microphones, touchscreen displays, etc.), and/or output devices (e.g., speakers, display devices, etc.) located in a cockpit of the aircraft 105 and/or in a copilot GBS 170, which can be utilized to facilitate communication exchanges between NLP system 520 and the pilots 560A, 560B. In some examples, the communication interfaces 560 can enable the NLP system 520 to output notifications to the pilots 560A, 560B and/or request verifications from the pilots 560A, 560B. In other examples, the communication interfaces 560 can enable the pilots 560A, 560B to transmit commands to the NLP system 520 (e.g., such as override commands and/or other commands for controlling the aircraft 105) and, upon receiving the commands, the NLP system 520 can interpret the intent of the commands and communicate with corresponding aircraft systems for implementing the commands.

Amongst other things, the communication interfaces 560 enable the onboard pilot 560A and/or remote copilot 560B to provide verifications in connection with performing verification functions 522 and/or authorizing actions to be performed by the autonomous controller 530. The communication interfaces 560 also enable the onboard pilot 560A and/or remote copilot 560B to issue override commands 561 to override, cancel, or modify actions or decisions undertaken by the autonomous controller 530. Other types of override controls 540, such as those that do not involve providing inputs via the communication interfaces 560, also may be provided which enable the onboard pilot 560A and/or remote copilot 560B to override, cancel, or modify actions or decisions undertaken by the autonomous controller 530.

The NLP system 520 also is directly or indirectly coupled with, and receives data from, a communications management system 154 installed on the aircraft 105. As described above, a remote copilot 560B located at a copilot GBS 170 may be connected to the aircraft 105 over a network 190 and the communications management system 154 installed on the aircraft 105 may facilitate bi-directional communications between the aircraft 105 and the copilot GBS 170. The NLP system 520 can process and execute various analysis functions on communications received via the communications management system 154 (e.g., such as to understand actions that being undertaken by the remote copilot and/or to implement commands received from the remote copilot).

The NLP system 520 also is directly or indirectly coupled with autonomous controller 520. Any analysis information generated by the NLP system 520 may be provided to the autonomous controller 530, which may utilize the information to gain a better understanding of the operational state 531A of the aircraft and/or to autonomously execute actions for controlling the aircraft 105.

As demonstrated above, the analysis information generated by the computer vision system 510 and/or NLP system 520 can be provided to the autonomous controller 530. The autonomous controller 530 also may be directly or indirectly coupled with various aircraft systems and components 570 (e.g., such as cockpit displays and controls 111, actuation switches and indicators 112, MCDU 113, data concentrators 121, FMSs 122, FSDCs 123, FGCs 124, multimode radios 125, aircraft sensor systems 131, and/or other devices and systems installed on the aircraft 105). Any data generated by the various aircraft systems and components 570 may be provided to, or accessed by, the autonomous controller 530.

The autonomous controller 530 may utilize the data received from the computer vision system 510, NLP system 520, and/or aircraft system and components 570 to execute the operational assessment functions 531 for ascertaining an operational state 531A of the aircraft, as well as to execute the decision-making functions 532 described herein. The autonomous controller 530 may generate and output various types of control signals 590 for autonomously operating, manipulating, or controlling the aircraft 105 and/or its various subsystems and components.

In one example, based on an analysis of the operational state 531A of the aircraft, the autonomous controller 530 may identify an obstacle in or near the aircraft's flight path and may transmit control signals 590 to the FMS 122 or FGC 124 to change a flight path or flight plan of the aircraft 105. In another example, the autonomous controller 530 may generate control signals 590 to adjust the aircraft's altitude in response to detecting adverse weather conditions at the current flight level. In another example, the autonomous controller 530 may transmit control signals 590 to activate de-icing systems when the operational state 531A indicates potential icing conditions. In another example, the autonomous controller 530 may generate control signals 590 to modify engine thrust settings to optimize fuel efficiency based on current atmospheric conditions and/or aircraft weight. In another example, the autonomous controller 530 may generate control signals 590 to adjust the aircraft's heading in order to avoid detected air traffic or restricted airspace zones. In a further example, the autonomous controller 530 may generate control signals 590 to deactivate a damaged or malfunctioning component, such as a faulty sensor or engine, while simultaneously activating a redundant component to maintain system integrity and operational safety. The decision-making functions 532 executed by the autonomous controller 530 can generate control signals 590 for many other scenarios or purposes as well.

The override controls 540 may enable the onboard pilot 560A and/or remote copilot 560B to maintain ultimate control over the aircraft's operations and systems. In some embodiments, these override controls 540 may allow the pilots to countermand or modify any decisions or actions initiated by the autonomous controller 530. This capability may help ensure that human judgment can always take precedence over AI-driven decisions, providing an additional layer of safety and flexibility in aircraft operations.

FIG. 6 illustrates a flow chart for an exemplary method 600 for operating an aircraft according to certain embodiments. Method 600 is merely exemplary and is not limited to the embodiments presented herein. Method 600 can be employed in many different embodiments or examples not specifically depicted or described herein. In some embodiments, the steps of method 600 can be performed in the order presented. In other embodiments, the steps of method 600 can be performed in any suitable order. In still other embodiments, one or more of the steps of method 600 can be combined or skipped. In many embodiments, the CPRS 150, AI control system 550, aircraft system 100B, system 100A and/or aircraft 105 can be configured to perform method 600 and/or one or more of the steps of method 600. In these or other embodiments, one or more of the steps of method 600 can be implemented as one or more computer instructions configured to run at one or more processing devices and configured to be stored at one or more non-transitory computer storage devices. Such non-transitory memory storage devices and processing devices can be part of an avionics or aircraft system such as the CPRS 150, AI control system 550, aircraft system 100B, system 100A and/or aircraft 105.

In step 610, a connection is established between an aircraft 105 and a copilot GBS 170 that enables a remote pilot to communicate with an onboard pilot and provide assistance with operating the aircraft 105. In certain embodiments, the connection may be established using one or more data links included in a CPRS 150 installed in the aircraft.

In step 620, an AI control system analyzes an operational state corresponding to the aircraft 105. In some examples, analyzing the operational state of the aircraft may include analyzing an exterior environment of the aircraft (e.g., such as aircraft or obstacles detected in a vicinity of the aircraft and/or weather conditions in the exterior environment), analyzing an interior environment of the aircraft (e.g., such as readings rendered on instruments or displays, equipment installed in an EE bay, conditions in passenger cabins or cargo bays, etc.), analyzing data from various aircraft systems or components (e.g., such as to determine the status or proper functioning of the systems or components), and/or analyzing flight parameters of the aircraft (e.g., such as the speed, altitude, fight plan, flight path, etc.).

In step 630, the AI control system autonomously initiates one or more actions for controlling operation of the aircraft based on the operational state of the aircraft. In some examples, the AI control system may initiate maneuvers, change a flight path or plan, cancel a landing approach, initiate autopilot or autoland functions, activate/deactivate various aircraft systems or components, optimize thrust or speed settings, and/or control other functionalities of the aircraft.

In step 640, the onboard pilot and the remote pilot are both provided with one or more override controls that enable both the onboard pilot and the remote pilot to override the one or more actions undertaken by the AI control system. The one or more override controls may enable the onboard pilot and/or remote pilot to maintain ultimate control of the aircraft. The one or more override controls may be implemented via voice-based commands received from the onboard pilot and/or remote pilot, interactive options presented on displays to the onboard pilot and/or remote pilot, physical controls installed in a cockpit of the aircraft and/or at the copilot GBS, and/or by other suitable means.

In certain embodiments, an aircraft system is provided which comprises: (a) an artificial intelligence (AI) control system installed in an aircraft that comprises an autonomous controller configured to: execute one or more operational assessment functions configured to analyze an operational state corresponding to the aircraft; and execute one or more decision-making functions configured to autonomously initiate actions for controlling operation of the aircraft based on the operational state of the aircraft; (b) a copilot replacement system (CPRS) installed in the aircraft that is configured to establish a connection with a copilot ground base station (GBS) via at least one data link, the connection enabling a remote pilot to communicate with an onboard pilot and provide assistance with operating the aircraft; and (c) wherein the AI control system is configured with one or more override controls that enable both the onboard pilot and the remote pilot to override any of the actions undertaken by the one or more decision-making functions executed by the autonomous controller with respect to autonomously controlling operation of the aircraft.

In certain embodiments, a method is provided for operating an aircraft which comprises: (i) establishing, by a copilot replacement system (CPRS) installed in an aircraft, a connection with a copilot ground base station (GBS) via at least one data link, the connection enabling a remote pilot to communicate with an onboard pilot and provide assistance with operating the aircraft; (ii) executing, by an autonomous controller of an AI control system installed in the aircraft, one or more operational assessment functions associated with analyzing an operational state corresponding to the aircraft; (iii) executing, by the autonomous controller, one or more decision-making functions for autonomously controlling operation of the aircraft based on the operational state of the aircraft; and (iv) providing one or more override controls that enable both the onboard pilot and the remote pilot to override any actions undertaken by the autonomous controller with respect to autonomously controlling operation of the aircraft.

In certain embodiments, an aircraft system is provided which comprises: (a) an artificial intelligence (AI) control system installed in an aircraft that is configured to execute analyze an operational state corresponding to the aircraft and autonomously initiate one or more actions for controlling operation of the aircraft based on the operational state; (b) a copilot replacement system (CPRS) installed in the aircraft that is configured to establish a connection with a copilot ground base station (GBS) via at least one data link, the connection enabling a remote pilot to communicate with an onboard pilot and provide assistance with operating the aircraft; and (c) one or more override controls that enable both the onboard pilot and the remote pilot to override, cancel, or modify the one or more actions undertaken by the AI control system with respect to autonomously controlling operation of the aircraft.

Embodiments disclosed herein include a copilot replacement system (CPRS) installed in an aircraft comprising: at least one cockpit monitoring system installed in a cockpit of the aircraft, the at least one cockpit monitoring system being configured to generate monitoring data for monitoring one or more displays installed in the cockpit of the aircraft; at least one monitoring, checklist and warning system (MCWS) installed in the cockpit of the aircraft, the at least one MCWS being configured to communicate with a pilot in connection with performing checklist functions, instrument monitoring functions, and warning functions; at least one data link; and at least one communication management system configured to facilitate communications with at least one copilot ground base station (GBS), wherein: the at least one communication management system is coupled to at least one data concentrator installed in the aircraft, and is configured to receive outputs from the at least one data concentrator; the at least one communication management system is coupled to the at least one cockpit monitoring system and is configured to receive the monitoring data from the at least one cockpit monitoring system; the at least one communication management system is coupled to the at least one data link and is configured to transmit the outputs received or derived from the at least one data concentrator and the monitoring data generated by the at least one cockpit monitoring system to the at least one copilot GBS via the at least one data link; and the at least one communication management system is configured to receive communications from the at least one copilot GBS via the at least one data link.

Embodiments disclosed herein include a method for operating a copilot replacement system (CPRS) installed in an aircraft, the method comprising: monitoring, by at least one cockpit monitoring system installed in a cockpit of the aircraft, one or more displays installed in the cockpit to generate monitoring data; communicating, by at least one monitoring, checklist and warning system (MCWS) installed in the cockpit of the aircraft, with a pilot in connection with performing checklist functions, instrument monitoring functions, and warning functions; transmitting, by at least one communication management system configured to facilitate communications with at least one copilot ground base station (GBS), the monitoring data generated by the at least one cockpit monitoring system and outputs received or derived from at least one data concentrator installed in the aircraft to the at least one copilot GBS via at least one data link; and receiving, by the at least one communication management system, communications from the at least one copilot GBS via the at least one data link.

Embodiments disclosed herein include an aircraft system installed in an aircraft comprising: a copilot replacement system (CPRS) that includes at least one cockpit monitoring system, at least one monitoring, checklist and warning system (MCWS), at least one communication management system, and at least one data link; at least one data concentrator; wherein: the at least one communication management system is configured to facilitate communications with at least one copilot ground base station (GBS) via the at least one data link: the at least one communication management system is coupled to the at least one data concentrator installed in the aircraft, and is configured to transmit outputs received from the at least one data concentrator to the at least one copilot GBS via the at least one data link; the at least one communication management system is coupled to the at least one cockpit monitoring system and is configured to transmit monitoring data received from the at least one cockpit monitoring system to the at least one copilot GBS via the at least one data link; and the at least one communication management system is configured to receive communications from the at least one copilot GBS via the at least one data link.

Embodiments disclosed herein include a copilot ground base station (GBS), comprising: at least one GBS communication management system configured to manage bi-directional communications between the copilot GBS and a copilot replacement system (CPRS) installed on an aircraft; at least one data converter unit (DCU) coupled to the at least one GBS communication management system, the at least one DCU configured to receive aircraft data from the CPRS installed on the aircraft and convert the aircraft data into one or more outputs that are adapted for display; at least one output display device configured to render a plurality of aircraft displays, at least in part, using the one or more outputs generated by the at least one DCU; and at least one data link coupled to the at least one GBS communication management system, the at least one data link configured to establish a connection that facilitates the bi-directional communications with the aircraft; and wherein the connection established between the copilot GBS and the aircraft enables a ground-based pilot to remotely monitor operations of the aircraft on the at least one output display device, communicate with an onboard pilot located in a cockpit of the aircraft, and transmit commands for controlling one or more functionalities of the aircraft.

Embodiments disclosed herein include a method for operating a copilot ground base station (GBS), the method comprising: establishing, via at least one data link, a connection that permits bi-directional communications between the copilot GBS and a copilot replacement system (CPRS) installed on an aircraft; receiving, by at least one GBS communication management system coupled to the at least one data link, aircraft data from the CPRS installed on the aircraft; converting, by at least one data converter unit (DCU) coupled to the at least one GBS communication management system, the aircraft data into one or more outputs that are adapted for display; and rendering, by at least one output display device, a plurality of aircraft displays using the one or more outputs generated by the at least one DCU; and wherein the connection established between the copilot GBS and the CPRS installed on the aircraft enables a ground-based pilot to remotely monitor operations of the aircraft on the at least one output display device, communicate with an onboard pilot located in a cockpit of the aircraft, and transmit commands for controlling one or more functionalities of the aircraft.

Embodiments disclosed herein include a copilot ground base station (GBS), comprising: at least one data link configured to establish a connection with an aircraft; at least one GBS communication management system coupled to the at least one data link; at least one data converter unit (DCU) coupled to the at least one GBS communication management system; and at least one output display device coupled to the at least one DCU; wherein: at least one GBS communication management system configured to manage bi-directional communications between the copilot GBS and a copilot replacement system (CPRS) installed on the aircraft; the at least one DCU configured to receive aircraft data from the CPRS installed on the aircraft and convert the aircraft data for display on the at least one output display device; and the at least one output display device is configured to render one or more aircraft displays, wherein a ground-based pilot may utilize the one or more aircraft displays to remotely monitor operations of the aircraft and transmit commands for controlling one or more functionalities of the aircraft.

As evidenced by the disclosure herein, the inventive techniques set forth in this disclosure are rooted in aviation technologies that overcome existing problems in dual-pilot or multi-pilot aircraft, including problems that require two or more onboard pilots to safely the aircraft. The techniques described in this disclosure provide a technical solution (e.g., one that utilizes improved CPRS, autonomous capabilities, remote copilot connectivity capabilities, and/or AI-based control systems) for overcoming the limitations associated with known techniques. This technology-based solution marks an improvement over existing capabilities and functionalities by enabling a single onboard pilot to safely control and navigate the aircraft.

The techniques and solutions described in this disclosure can be applied to navigation systems for any type of aircraft (e.g., commercial airplanes, military airplanes, helicopters, air ships, drones, autonomous aircraft, etc.). Appropriate adaptations or modifications can be incorporated to tailor these techniques and solutions to particular types of aircraft.

Each of the components illustrated in FIG. 1B, 3A-3B, and 5A-5B (including components 111-113, 121-125, 131-139, 171-176, 181-187, 510, 520, 530, 540, and 550) can include one or more processing devices for executing their respective functions described herein. Each of these components also can include one or more computer storage devices that store instructions to facilitate these and other functions, and the instructions can be executed by the one or more processing devices.

The one or more processing devices may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions.

The one or more computer storage devices may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc.

Embodiments may include a computer program product accessible from a computer-usable or computer-readable medium providing program code for use by or in connection with a computer or any instruction execution system. The computer program product may store instructions for implementing the functionality of the navigation system and/or other component described herein. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or storage devices through intervening private or public networks. Satellite transceivers, wireless transceivers, modems, and Ethernet cards are just a few of the currently available types of network adapters.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components is for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. An aircraft system comprising:
an artificial intelligence (AI) control system installed in an aircraft that comprises an autonomous controller configured to:
execute one or more operational assessment functions configured to analyze an operational state corresponding to the aircraft; and
execute one or more decision-making functions configured to autonomously initiate actions for controlling operation of the aircraft based on the operational state of the aircraft;
a copilot replacement system (CPRS) installed in the aircraft that is configured to establish a connection with a copilot ground base station (GBS) via at least one data link, the connection enabling a remote pilot to communicate with an onboard pilot and provide assistance with operating the aircraft;
wherein the AI control system is configured with one or more override controls that enable both the onboard pilot and the remote pilot to override any of the actions undertaken by the one or more decision-making functions executed by the autonomous controller with respect to autonomously controlling operation of the aircraft.

2. The aircraft system of claim 1, wherein executing one or more operational assessment functions to analyze the operational state corresponding to the aircraft includes at least one of:
analyzing an exterior environment in which the aircraft operates;
analyzing an interior environment within the aircraft;
analyzing data received from one or more systems or components; or
analyzing flight parameters of the aircraft.

3. The aircraft system of claim 1, wherein the operational state of the aircraft is analyzed using one or more of:
analysis information generated by a computer vision system integrated with the AI control system, which processes visual data captured by one or more vision systems installed on exterior or interior of the aircraft;
analysis information generated by a natural language processing (NLP) system integrated with the AI control system, which processes text, voice, or audio communications; and
data received from the one or more aircraft systems or components coupled with the autonomous controller.

4. The aircraft system of claim 1, wherein the AI control system includes a natural language processing (NLP) system configured to:
notify the onboard pilot and the remote pilot of one or more actions that have been undertaken, or which are intended to be undertaken, by the autonomous controller in connection with autonomously controlling operation of the aircraft; and
receive an override command from either the onboard pilot or the remote pilot for overriding, cancelling, or modifying the one or more actions.

5. The aircraft system of claim 1, wherein:
a communications management system installed on the aircraft controls communications with the remote pilot;
the communications management system transmits one or more notifications to the remote pilot via the at least one data link which identify one or more actions that have been initiated, or will be initiated, by the autonomous controller for controlling operation of the aircraft; and
an override command is transmitted by the remote pilot over the network to the aircraft to override, cancel, or modify the one or more actions initiated by the autonomous controller.

6. The aircraft system of claim 1, wherein:
the AI control system includes a natural language processing (NLP) system that monitors and interprets communications received by the aircraft; and
the decision-making functions executed by the autonomous controller are configured to execute one or more actions for autonomously controlling operation of the aircraft based on the communications received by the aircraft.

7. The aircraft system of claim 6, wherein:
the NLP system is coupled directly or indirectly to one or more radio devices or one or more ADS-B (automatic dependent surveillance-broadcast) systems installed on the aircraft;
the NLP system analyzes the communications received via the one or more radio devices or the one or more ADS-B systems and generates analysis information corresponding to the communications; and
the autonomous controller executes the one or more actions based, at least in part, on the analysis information generated by the NLP system.

8. The aircraft system of claim 1, wherein:
the AI control system includes a computer vision system configured to receive visual data captured by an exterior vision system of the aircraft;
the computer vision system analyzes the visual data to generate analysis information corresponding to an exterior environment of the aircraft; and
the autonomous controller executes one or more actions based, at least in part, on the analysis information generated by the computer vision system.

9. The aircraft system of claim 8, wherein the autonomous controller executes the one or more actions in response to the analysis information identifying:
one or more air-based obstacles in or near a flight path of the aircraft;
one or more ground-based obstacles in or near a landing surface;
weather conditions in a current vicinity of the aircraft or in an upcoming flight path of the aircraft;
air traffic conditions in or near a flight path of the aircraft; or
an unapproved landing surface for landing the aircraft in an emergency situation.

10. The aircraft system of claim 1, wherein:
the AI control system includes a computer vision system configured to receive visual data captured inside of the aircraft;
the computer vision system analyzes the visual data to generate analysis information corresponding to an interior environment of the aircraft; and
the autonomous controller executes one or more actions based the analysis information generated by the computer vision system.

11. The aircraft system of claim 10, wherein the autonomous controller executes the one or more actions in response to:
interpreting data presented on an instrument or display located in a cockpit of the aircraft;
identifying equipment inside the aircraft that has been damaged or which is malfunctioning;
analyzing activities of passengers located in a passenger cabin of the aircraft; or
monitoring conditions in a cargo bay of the aircraft.

12. The aircraft system of claim 1, wherein the one or more override controls are implemented using at least one of:
voice-based override commands that can be spoken by the onboard pilot or the remote pilot;
interactive options presented on one or more display devices located in a cockpit of the aircraft or at the copilot ground base station; or
physical controls located in the cockpit of the aircraft or at the copilot ground base station.

13. The aircraft system of claim 1, wherein the onboard pilot is provided access to both:
the one or more override controls that enable the onboard pilot to override any actions undertaken by the autonomous controller with respect to autonomously controlling operation of the aircraft; and
one or more additional override controls that enable the onboard pilot to override control of the aircraft by the remote pilot and/or sever the connection to the copilot GBS.

14. A method of operating an aircraft comprising:
establishing, by a copilot replacement system (CPRS) installed in an aircraft, a connection with a copilot ground base station (GBS) via at least one data link, the connection enabling a remote pilot to communicate with an onboard pilot and provide assistance with operating the aircraft;
executing, by an autonomous controller of an AI control system installed in the aircraft, one or more operational assessment functions associated with analyzing an operational state corresponding to the aircraft;
executing, by the autonomous controller, one or more decision-making functions for autonomously controlling operation of the aircraft based on the operational state of the aircraft; and
providing one or more override controls that enable both the onboard pilot and the remote pilot to override any actions undertaken by the autonomous controller with respect to autonomously controlling operation of the aircraft.

15. An aircraft system comprising:
an artificial intelligence (AI) control system installed in an aircraft that is configured to execute analyze an operational state corresponding to the aircraft and autonomously initiate one or more actions for controlling operation of the aircraft based on the operational state;
a copilot replacement system (CPRS) installed in the aircraft that is configured to establish a connection with a copilot ground base station (GBS) via at least one data link, the connection enabling a remote pilot to communicate with an onboard pilot and provide assistance with operating the aircraft; and
one or more override controls that enable both the onboard pilot and the remote pilot to override, cancel, or modify the one or more actions undertaken by the AI control system with respect to autonomously controlling operation of the aircraft.
